(19) United States
(12) Patent Application Publication
(10) Pub. No.: US 2009/0246422 A1
(43) Pub. Date: Oct. 1, 2009

(54) INKJET RECORDING MEDIUM AND METHOD FOR MANUFACTURING THE SAME

(75) Inventor: Ryoichi Nakano, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 12/088,392

(22) PCT Filed: Sep. 8, 2006
(86) PCT No.: PCT/JP2006/318319

§ 371 Date: Mar. 27, 2008

(30) Foreign Application Priority Data
Sep. 28, 2005 (JP) 2005-282489

(51) Int. Cl. B41M 5/40; B05D 3/10

(52) U.S. Cl. 428/32.31; 427/340

(57) ABSTRACT

An inkjet recording medium comprising an ink receiving layer provided on a support. The ink receiving layer includes a compound containing a sulfur atom, and a center plane average roughness (SRa value) on a surface of the ink receiving layer is less than 6 nm when measured under a condition of a cutoff of 2 to 2.5 μm.

### TECHNICAL FIELD

The present invention relates to an inkjet recording medium, which is a recorded medium suitably used for inkjet recording method, and a method for manufacturing the same.

### BACKGROUND ART

In recent years, a variety of information processing systems such as an inkjet recording method, a thermal recording method, a pressure sensitive recording method, a photosensitive recording method, and a transfer-type recording method have been developed with rapid advancements in information-technology industry; and recording methods and recording instruments suitable for these information processing systems have also been developed and put into practical use.

Among others, the inkjet recording method has been used widely in home use in addition to office use as a matter of course, in view of such advantages as capability of recording on a variety of recording materials, relatively inexpensive and compact hardware (apparatus), and excellent quietness.

With an increase in resolution of inkjet printers in recent years, it has become possible to obtain a high-quality recorded material, a so-called photo-like recorded material. A variety of recording sheets for inkjet recording have been developed also with such progress of hardware (apparatuses) as mentioned above.

Characteristics required for a recording medium for inkjet recording include commonly (1) quick-drying (high ink absorption rate), (2) adequate and uniform diameter of ink dots (no bleeding), (3) good graininess, (4) high circularity of dots, (5) high color concentration, (6) high color saturation (dullness-free), (7) excellent water resistance, light resistance, and ozone resistance of a printed area, (8) high whiteness of a recording sheet, (9) good storability of the recording sheet (no yellowing or discoloration even in long storage), and no bleeding in the image even during long storage (excellent suppression of bleed with time), (10) resistance to deformation and good dimensional stability (sufficiently small curl), and (11) good traveling performance in hardware.

In an application for photographic glossy paper which is used for the purpose of obtaining a so-called photo-like high-quality recording product, it is required for the paper to have glossiness, glossiness of printed area, surface smoothness, photographic paper-like feeling similar to silver salt photography, and the like, in addition to the above-described various characteristics.

For the purpose of improving the above-described various characteristics, an inkjet recording medium in which the recording layer has a porous structure has been developed and put into practical use in recent years. Since such an inkjet recording medium involves the porous structure, the recording medium is excellent in ink receiving property (quick-drying) and has high glossiness.

For instance, an inkjet recording medium has been proposed which has, on a support, a recording layer having high void fraction and containing fine inorganic pigment particles and a water-soluble resin (see Japanese Patent Application Laid-Open Nos. (JP-A) 10-119423 and 10-217601).

These inkjet recording sheets, particularly the inkjet recording medium having a recording layer of a porous structure containing silica as the inorganic fine particles, exhibit excellent ink absorbing property owing to the structure thereof, and have high ink receiving performance that enables formation of an image of high resolution and high glossiness.

However, such recording sheets have a problem in that the gas permeability is high due to the porous film, which may accelerate the deterioration of the components contained in the recording layer.

A trace gas in the air, particularly ozone, can be a cause for fading of a recorded image with age. Since the recording materials having a recording layer of the above-mentioned porous structure have a lot of voids, the recorded image is easily faded by ozone in the air. Therefore, resistance to ozone gas (ozone resistance) is a very important characteristic for a recording material having a recording layer of the above-described porous structure.

A variety of inkjet recording media aiming at satisfying the above-described various characteristics have been reported.

For instance, inkjet recording media to which a liquid prepared by dispersing inorganic fine particles in the presence of a water-soluble polyvalent metal compound is applied are disclosed in JP-A Nos. 8-118787, 2000-351267, and 2002-320842 for the sake of achieving ink absorbing property, improvements in image density, water resistance, glossiness, weather resistance, and prevention of coating defects.

Although the water-soluble polyvalent metal compound provides the above-described ozone resistance, the ozone resistance was not always sufficient.

In JP-A No. 2005-7849, an inkjet recording medium using a sulfoxide-containing compound and a water-soluble polyvalent metal salt is disclosed. Further, in JP-A No. 2003-200657, an inkjet recording sheet is disclosed which has a colorant receiving layer containing cationic polymer-modified inorganic pigment fine particles prepared from a cationic polymer having a group capable of combining with the inorganic pigment fine particle at the terminal thereof, and the inorganic pigment fine particles.

These inkjet recording sheets described in JP-A Nos. 2005-7849 and 2003-200657, however, also fails to satisfy all of the ozone resistance, bleed, and image density (the image density of black).

When an additive for rendering ozone resistance is added, the ozone resistance can be realized; however, there arises a problem in that the image density decreases. Accordingly, it has been difficult to provide the ozone resistance and prevention the decrease in image density simultaneously.

### DISCLOSURE OF THE INVENTION

The present invention has been made in view of the above-described situation, and provides an inkjet recording medium and a method for manufacturing the same.

A first aspect of the invention provides an inkjet recording medium having an ink receiving layer on a support. The ink receiving layer contains a compound containing a sulfur atom, and the center plane average roughness (SRa value) on the surface of the ink receiving layer is less than 6 nm when measured under the condition of a cutoff of 2 to 2.5 μm.

A second aspect of the invention provides an inkjet recording medium having an ink receiving layer on a support. The ink receiving layer contains a sulfoxide-containing compound, and the center plane average roughness (SRa value) on the surface of the ink receiving layer is 11 nm or less when measured under the condition of a cutoff of 2 to 2.5 μm.

A third aspect of the invention provides a method for manufacturing the inkjet recording medium according to either of the first or second aspect. The method includes at least:

(A): applying a first liquid containing at least a water-soluble resin and a crosslinking agent onto a support to form a coated layer; and

(B) applying a second liquid containing a basic compound onto the coated layer (1) simultaneously with the application of the first liquid, or (2) before the coated layer exhibits decreasing drying during the drying of the coated layer formed by the application of the first liquid, to crosslink and cure the coated layer to form an ink receiving layer. At least one of the first and second liquids contains a compound containing sulfur.

A fourth aspect of the invention provides a method for manufacturing the inkjet recording medium according to either of the first or second aspect. The method includes dispersing at least some of the components in a coating liquid for forming the ink receiving layer by a head-on collision high-pressure disperser or an orifice-passing high-pressure disperser during preparation of the coating liquid.

A fifth aspect of the invention provides a method for manufacturing an inkjet recording medium having an ink receiving layer including a compound containing a sulfur atom. The center plane average roughness (SRa value) on the surface of the ink receiving layer is 11 nm or less when measured under the condition of a cutoff of 2 to 2.5 μm. The method includes at least:

(A): applying a first liquid containing at least a water-soluble resin and a crosslinking agent onto a support to form a coated layer; and

(B) applying a second liquid containing a basic compound onto the coated layer (1) simultaneously with the application of the first liquid, or (2) before the coated layer exhibits decreasing drying during the drying of the coated layer formed by the application of the first liquid, to crosslink and cure the coated layer to form an ink receiving layer. At least one of the first and second liquids contains a compound containing sulfur. The viscosity of the first liquid before exhibiting the decreasing drying is 6000 Pa or more at a shear rate of 1 s⁻¹.

### BEST MODE FOR CARRYING OUT THE INVENTION

In the following, the inkjet recording medium according to the present invention will be described.

An inkjet recording medium according to a first embodiment has an ink receiving layer on a support, the ink receiving layer includes a compound containing a sulfur atom, and the center plane average roughness (SRa value) on the surface of the ink receiving layer on which an image is to be formed is less than 6 nm when measured under the condition of a cutoff of 2 to 2.5 μm.

In the present invention, the expression “cut off of X (mm) to Y (mm)” refers to the use of cut-off filters that substantially remove the wavelength regions other than the wavelength region of X (mm) to Y (mm).

An inkjet recording medium according to a second embodiment has an ink receiving layer on a support, the ink receiving layer includes a sulfoxide-containing compound, and the center plane average roughness (SRa value) on the surface of the ink receiving layer on which an image is to be formed is 11 nm or less when measured under the condition of a cutoff of 2 to 2.5 μm.

Hereinafter, the description of the condition “when measured under the condition of a cutoff of 2 to 2.5 μm” is sometimes omitted when referring to a center plane average roughness (SRa value), in which case the center plane average roughness (SRa value) refers to the value measured under the condition described above.

The first embodiment of the invention differs from the second embodiment of the invention in the compound contained in the ink receiving layer (either a compound containing a sulfur atom or a sulfoxide-containing compound), and the center plane average roughness (SRa value) (either less than 6 nm, or 11 nm or less). In this respect, since a sulfoxide-containing compound is an example of a compound containing a sulfur atom, the second embodiment can be considered to be a practical mode of the first embodiment. Accordingly, the respective embodiments are explained simultaneously while mainly focusing on the first embodiment.

### <Ink Receiving Layer>

The ink receiving layer according to the invention includes a compound containing a sulfur atom in addition to the major components constituting the ink receiving layer such as inorganic fine particles, a water-soluble resin, and a mordant. In the invention, the compound containing a sulfur atom is a compound that can be oxidized. Accordingly, when the compound is added to the ink receiving layer, it functions to improve the ozone resistance of the ink receiving layer. However, the inventor has found that when the compound containing a sulfur atom is added to the ink receiving layer, the surface thereof becomes coarse, so that the image density decreases due to diffused reflection of light. In the invention, prevention of decrease in the image density and improvement in ozone resistance are attained simultaneously by defining the center plane average roughness (SRa value) on the surface of the ink receiving layer.

### [Center Plane Average Roughness (SRa)]

In the invention, a center plane average roughness (SRa value) on the surface of the ink receiving layer measured under the condition of 2 to 2.5 μm cutoff is less than 6 nm in the first embodiment, and 11 nm or less in the second embodiment. When the center plane average roughness (SRa value) exceeds 11 nm, decrease in the image density due to diffused reflection cannot be prevented.

The center plane average roughness is preferably 5 nm or less, and more preferable is 4 nm or less in the first embodiment, while the center plane average roughness is preferably 10 nm or less, and more preferable is 8 nm or less in the second embodiment.

The center plane average roughness (SRa) means the average roughness obtained by three-dimensionally scanning the roughness on a certain flat plane, and is a different concept from a center line roughness (Ra value) obtained by scanning a linear roughness of a flat plane. Concavities and convexities on the surface of a base material are not uniform, and there are wavy concavities and convexities having a variety of wavelengths. The expression “measurement under 2 to 2.5 μm cutoff condition” means a measurement of the concavities and convexities having a wavelength of 2 to 2.5 μm.

A method for measuring the center plane average roughness (SRa) in the invention will be described.

The measurement of the center plane average roughness (SRa) under the condition of a cutoff of 2 to 2.5 μm is conducted by using NEW VIEW 5022 manufactured by Zygo Corporation based on the following measurement and analysis conditions.

### [Measurement and Analysis Conditions]

Measurement length: 5 mm in X direction, 5 mm in Y direction

Objective lens: 50 magnifications

Bandpass filter: 2 to 2.5 μm

In the invention, in order to make the center plane average roughness (SRa value) on the surface of an ink receiving layer 11 nm or less, the viscosity of the coating liquid for forming the ink receiving layer may be adjusted. The embodiment therefor will be mentioned later in the method for manufacturing an inkjet recording medium of the invention.

When the center plane average roughness (SRa value) on the surface of the ink receiving layer is set at less than 6 nm, it is preferred to use a head-on collision high-pressure disperser or an orifice-passing high-pressure disperser for dispersing the ingredients during the preparation of the coating liquid.

The head-on collision high-pressure disperser is a high-pressure disperser that disperses the ink receiving layer coating liquid by head-on collision. The orifice-passing high-pressure disperser is a disperser that disperses the ink receiving layer coating liquid by passing the coating liquid through an orifice. The disperser is not specifically limited so far as the disperser is capable of causing a head-on collision of the ink receiving layer coating liquids at high pressure, or capable of passing the ink receiving layer coating liquid through an orifice at high pressure. In general, commercially available apparatuses called high-pressure homogenizer may suitably be used.

Typical examples of high-pressure homogenizers include: NANOMIZER LA-31 (trade name), manufactured by Nanomizer Corporation; MICROFLUIDIZER (trade name), manufactured by Microfluidics Corporation; and ULTIMAIZER (trade name) manufactured by Sugino Machine Corporation.

The orifice described above refers to a mechanism which has a thin plate (orifice plate) having minute openings with a shape of a circle or the like inserted in a straight pipe, and which rapidly narrowing the flow path of the straight pipe.

The above-described high-pressure homogenizer is basically composed of a high-pressure generation section that pressurizes raw material slurry or the like, and a head-on collision section or an orifice section. For the high-pressure generation section, a high-pressure pump, which is commonly called a plunger pump, can be suitably applied. There are high-pressure pumps of a variety of types such as a single pump, a dual pump, and a triple pump; pumps of any type can be used in the invention without particular restrictions.

### [Compound Containing Sulfur Atom]

Next, a compound containing a sulfur atom will be described.

The compound containing a sulfur atom is a compound that can be oxidized as described hereinbefore.

The compound containing a sulfur atom is preferably a compound having a thioether group, or a sulfoxide-containing compound, and particularly preferably a sulfoxide-containing compound. In the following, the respective compounds are described in detail.

### —Compound Containing a Thioether Group—

The compound containing a thioether group according to the invention is not particularly limited, and examples thereof include compounds containing a sulfur atom and aromatic groups bonded to the both sides of the sulfur atom (the following <1> to <3>), compounds containing a sulfur atom and alkyl groups (having preferably four or more carbon atoms) sandwiching the sulfur atom (the following <4> to <5>), DL-methionine, and 2-(ethylthio)ethanol.

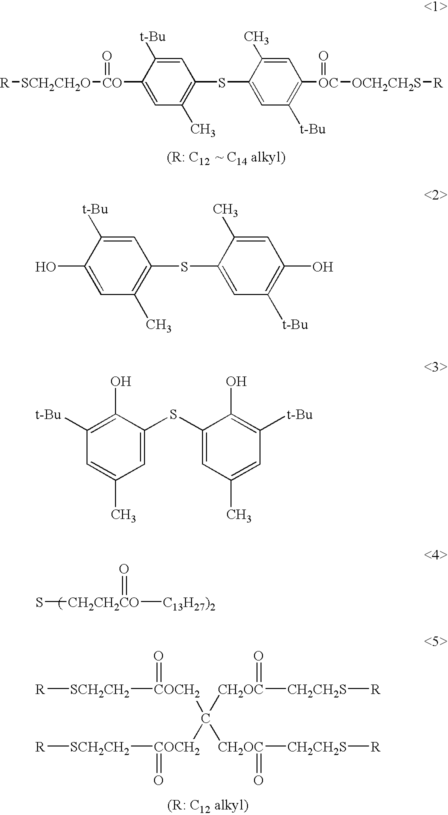

The content of any of the thioether compound in the ink receiving layer is preferably from 0.1 to 50 mmol/m², and more preferably from 0.2 to 20 mmol/m².

### —Sulfoxide-Containing Compound—

The sulfoxide-containing compound according to the invention is not particularly limited, but preferably has at least one structure represented by the following formula (1) in the molecule.

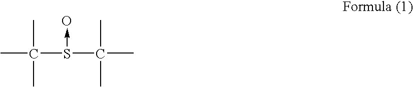

The sulfoxide-containing compound having a structure represented by the formula (1) may be substituted by a hydrophilic group. Examples of the hydrophilic group include substituted or unsubstituted amino groups, substituted or unsubstituted carbamoyl groups, substituted or unsubstituted sulfamoyl groups, substituted or unsubstituted ammonium, hydroxyl group, sulfonic acid, carboxylic acid, phosphoric acid, ethyleneoxy acid, and substituted or unsubstituted nitrogen-containing heterocycles.

Moreover, the sulfoxide-containing compound is preferably a compound represented by the following formula (2).

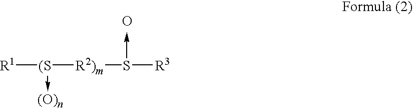

In formula (2), R¹ and R³ each independently represent a substituted or unsubstituted alkyl group, a substituted or unsubstituted aryl group, a substituted or unsubstituted heterocyclic group, or a polymer residue composed of such groups. R¹ and R³ may be the same as or different from each other. R¹ and R³ may combine with each other to form a ring. R² represents a substituted or unsubstituted bi- to hexa-valent linking group. R² may combine with R¹ or R² to form a ring, or combine with R² or R³ to form a ring. m is 0 or an integer of 1 or greater. n is 0 or 1. At least one of R¹, R², and R³ represents an alkyl group, an aryl group, a heterocyclic group, or a polymer residue each of which is substituted by a hydrophilic group selected from a substituted or unsubstituted amino group, a substituted or unsubstituted carbamoyl group, a substituted or unsubstituted sulfamoyl group, a substituted or unsubstituted ammonium, a hydroxyl group, a sulfonic acid, a carboxylic acid, a phosphoric acid, an ethyleneoxy group, and a substituted or unsubstituted nitrogen-containing heterocycle.

The unsubstituted alkyl group represented by R¹ or R³ in the formula (2) may have a straight-chain, branched, or cyclic structure, and may contain an unsaturated bond. For example, alkyl groups having 1 to 22 carbon atoms are preferable. Specifically, the alkyl group is preferably a methyl group, an ethyl group, an allyl group, a n-butyl group, a n-hexyl group, a n-octyl group, a benzyl group, an iso-propyl group, an iso-butyl group, a sec-butyl group, a cyclohexyl group, or a 2-ethylhexyl group, more preferably an alkyl group having 1 to 10 carbon atoms, and particularly preferably a methyl group, an ethyl group, an allyl group, a n-propyl group, an iso-butyl group, a cyclohexyl group, or a 2-ethylhexyl group.

The unsubstituted aryl group represented by R¹ or R³ is preferably, for example, an aryl group having 6 to 22 carbon atoms. Specific examples thereof include a phenyl group, a 1-naphthyl group, and a 2-naphthyl group, and a phenyl group is particularly preferable.

Examples of the unsubstituted heterocyclic group represented by R¹ or R³ include a thienyl group, a thiazolyl group, an oxazolyl group, a pyridyl group, a pyrazyl group, a thiadiazoyl group, a triazoyl group, a morphoryl group, a piperazyl group, a pyrimidyl group, a triazyl group, an indolyl group, a benzothiazoyl group, and a benzoxazoyl group; among others, a thiazolyl group, an oxazolyl group, a pyridyl group, a thiadiazoyl group, a triazoyl group, a morphoryl group, a pyrimidyl group, a triazyl group, a benzothiazoyl group, and a benzoxazoyl group are particularly preferred.

When R¹ or R³ represents a polymer residue composed of groups selected from substituted or unsubstituted alkyl groups, aryl groups, and heterocyclic residues, an example of the polymer residue is a polymer having any of the following units.

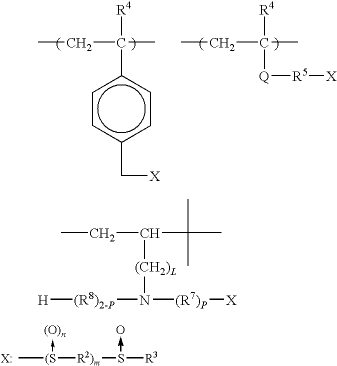

wherein R⁴ represents a hydrogen atom, or an alkyl group having 1 to 4 carbon atoms; R⁵ represents an alkylene group; Q represents a linking group; R⁷ and R⁸ each independently represent an alkylene group; L represents 1 or 2; P represents 1 or 2; R², R³, m, and n have the same definitions as R², R³, m, and n in the formula (2), respectively.

An example of the linking group represented by Q in the above unit is any of the following linking groups:

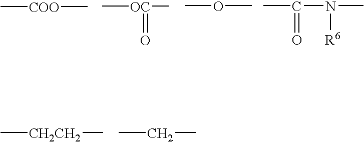

wherein R⁶ represents a hydrogen atom, an alkyl group, or an aryl group.

When R¹ or R³ represents a substituted alkyl, aryl, or heterocyclic group, examples of the substituent(s) include substituted or unsubstituted amino groups (e.g. amino groups having 30 or less carbon atoms, an amino group, alkylamino groups, dialkylamino groups, arylamino groups, and acylamino groups); substituted or unsubstituted carbamoyl groups (e.g. carbamoyl groups having 30 or less carbon atoms, a carbamoyl group, a methylcarbamoyl group, a dimethylcarbamoyl group, a morpholinocarbamoyl group, and a piperidinocarbamoyl group); substituted or unsubstituted ammoniums (e.g. ammoniums having 30 or less carbon atoms, ammonium, trimethylammonium, triethylammonium, dimethylbenzylammonium, and hydroxyethyldimethylammonium); substituted or unsubstituted sulfamoyl groups (e.g. sulfamoyl groups having 30 or less carbon atoms, a sulfamoyl group, a methylsulfamoyl group, a dimethylsulfamoyl group, a morpholinosulfamoyl group, and a piperidinosulfamoyl group); substituted or unsubstituted nitrogen-containing heterocycles (e.g. a pyridyl group, a pyrimidyl group, a morpholino group, a pyrrolidino group, a piperidino group, and a piperazyl group); hydrophilic groups represented by a hydroxyl group, a sulfonic acid, a carboxylic acid, a phosphoric acid, an ethyleneoxy group and the like; a cyano group; halogen atoms (e.g. a fluorine atom, a chlorine atom, and a bromine atom); substituted or unsubstituted alkoxycarbonyl groups (e.g. alkoxycarbonyl groups having 30 or less carbon atoms, a methoxycarbonyl group, an ethoxycarbonyl group, a dimethylaminoethoxyethoxycarbonyl group, a diethylaminoethoxycarbonyl group, and a hydroxyethoxycarbonyl group); substituted or unsubstituted aryloxycarbonyl groups (e.g. aryloxycarbonyl groups having 30 or less carbon atoms, and a phenoxycarbonyl group); substituted or unsubstituted alkoxy groups (e.g. alkoxy groups having 30 or less carbon atoms, a methoxy group, an ethoxy group, a phenoxyethoxy group, a buthoxyethoxy group, and a hydroxyethoxy group); substituted or unsubstituted aryloxy groups (e.g. aryloxy groups having 30 or less carbon atoms, and a phenoxy group); substituted or unsubstituted acyloxy groups (e.g. acyloxy groups having 30 or less carbon atoms, an acetyloxy group, and a propionyloxy group); and substituted or unsubstituted acyl groups (e.g. acyl groups having 30 or less carbon atoms, an acetyl group, and a propionyl group).

R¹ and R³ may be the same as or different from each other, and may combine with each other to form a ring.

R² represents a substituted or unsubstituted divalent to hexavalent linking group. R² may be bonded to R¹ or R², or R² or R³ to form a ring. Examples of the sulfur-containing heterocycle formed by such a bonding include a thienyl group, a thiazoyl group, a thiazolidyl group, a dithiolan-2-yl group, a trithian-2-yl group, and a dithian-2-yl group.

Examples of the divalent to hexavalent linking group represented by R² include those containing carbon, nitrogen, oxygen, or phosphor; and a specific examples thereof include the following linking groups.

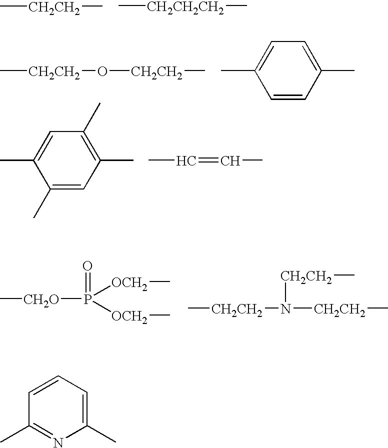

These linking groups may contain a hetero bond such as an ether bond, an ester bond, an amino bond, an amide bond, or a urethane bond, and may have a substituent. A polymer composed of a repetition of linking groups selected from the above may also be used, in which the respective linking groups may be the same as or different from each other.

At least one of R¹, R², and R³ represents an alkyl group, an aryl group, a heterocyclic group, or a polymer residue each of which is substituted by a hydrophilic group represented by a substituted or unsubstituted amino group, a substituted or unsubstituted carbamoyl group, a substituted or unsubstituted sulfamoyl group, a substituted or unsubstituted ammonium, a hydroxyl group, a sulfonic acid, a carboxylic acid, a phosphoric acid, an ethyleneoxy group, or a substituted or unsubstituted nitrogen-containing heterocycle. The hydrophilic group may be selected from the substituents mentioned in the description of R¹ and R³.

Since the preparation of the inkjet recording medium of the invention involves practically aqueous coating, the sulfoxide-containing compound according to the invention is preferably water-soluble.

Such a sulfoxide-containing compound is a Lewis base, which has higher solubility in water than a thioether compound. Therefore, the sulfoxide-containing compound can be added in a larger amount than a thioether compound.

When the sulfoxide-containing compound according to the invention is water-soluble, it is preferred to add the sulfoxide-containing compound to a coating liquid or basic solution containing the after-mentioned fine particles and water-soluble resin.

When the sulfoxide-containing compound according to the invention is oil-soluble, it is preferred to add the sulfoxide-containing compound to the coating liquid or basic solution containing fine particles and a water-soluble resin after the sulfoxide-containing compound is emulsified or after the sulfoxide-containing compound is added to an organic solvent.

In the inkjet recording medium according to the invention, the content of the sulfoxide-containing compound is preferably 0.01 to 20 g/m², and more preferably 0.05 to 7 g/m² in view of further improvement in ozone resistance, resistance to bleed (image bleed) with age, and glossiness.

In the inkjet recording medium according to the invention, the sulfoxide-containing compound, which generally has a higher oxidation potential than conventional sulfur-containing compounds (thioethers, thioureas), can achieve higher ozone resistance and higher light resistance when combined with a superior colorant having a high oxidation potential for the sake of improving the ozone resistance and the light resistance.

Only a single sulfoxide-containing compound according to the invention may be used, or two or more sulfoxide-containing compounds according to the invention may be used in combination.

Specific examples (exemplary compounds A-1 to A-75) of the sulfoxide-containing compound will be shown below, but the invention is not limited thereto.

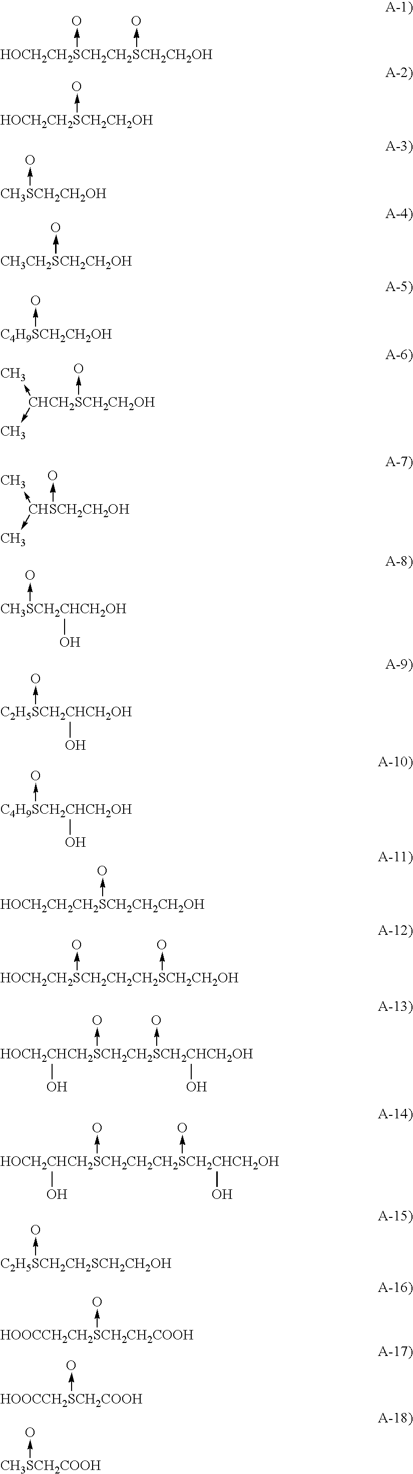

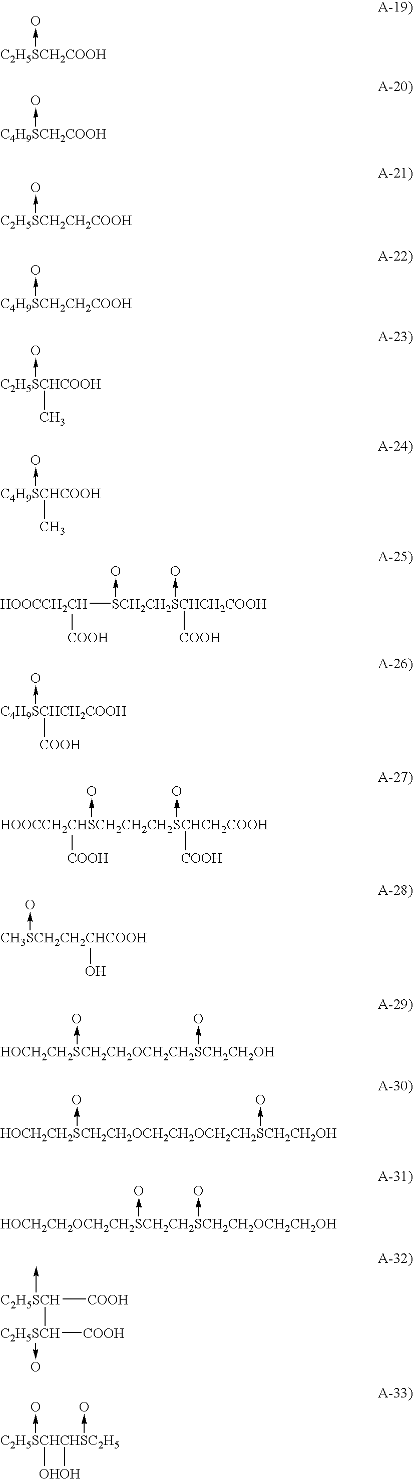

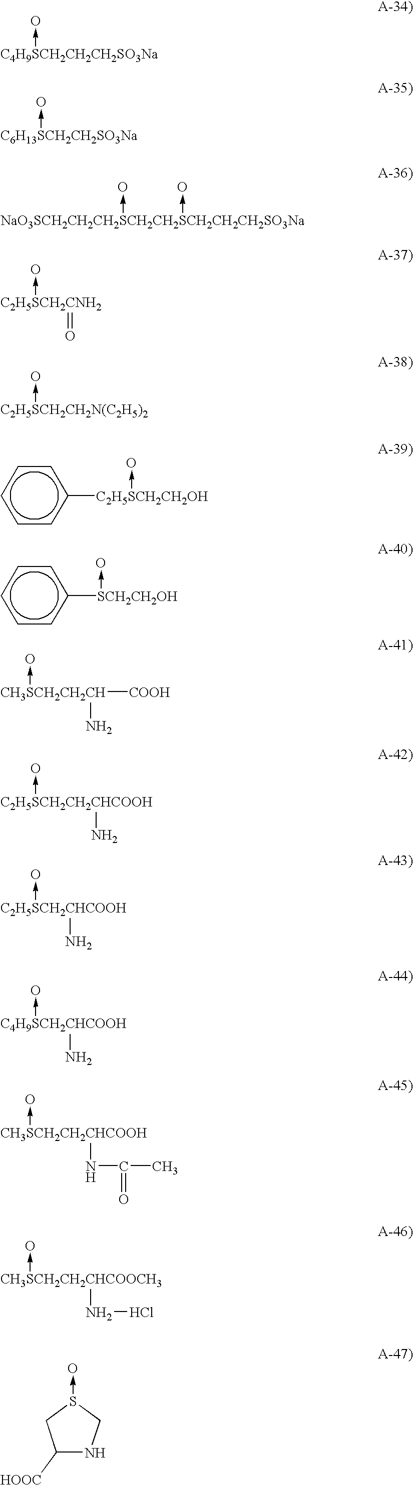

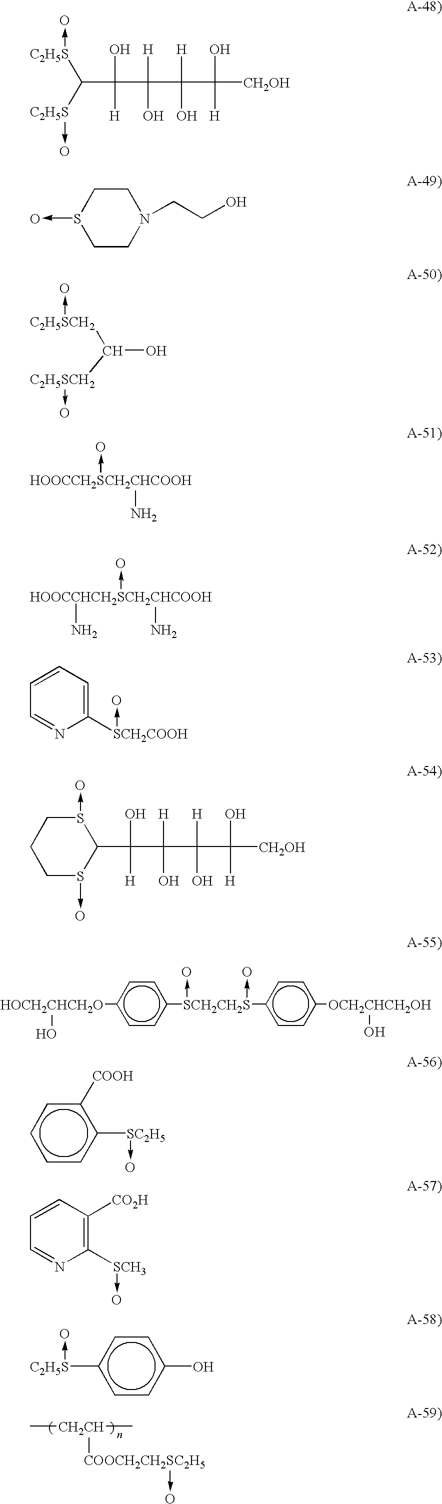

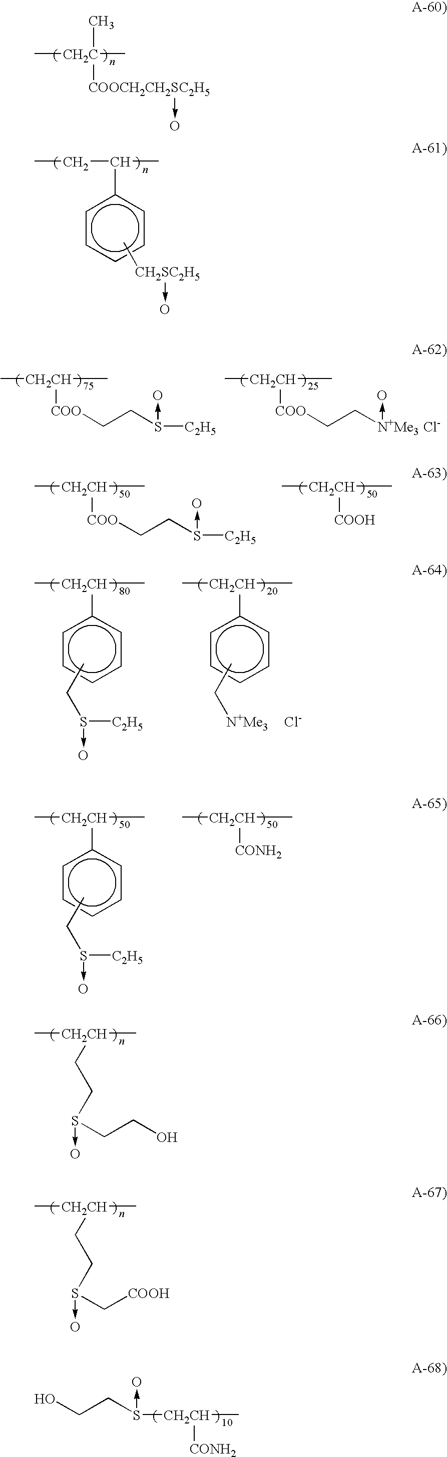

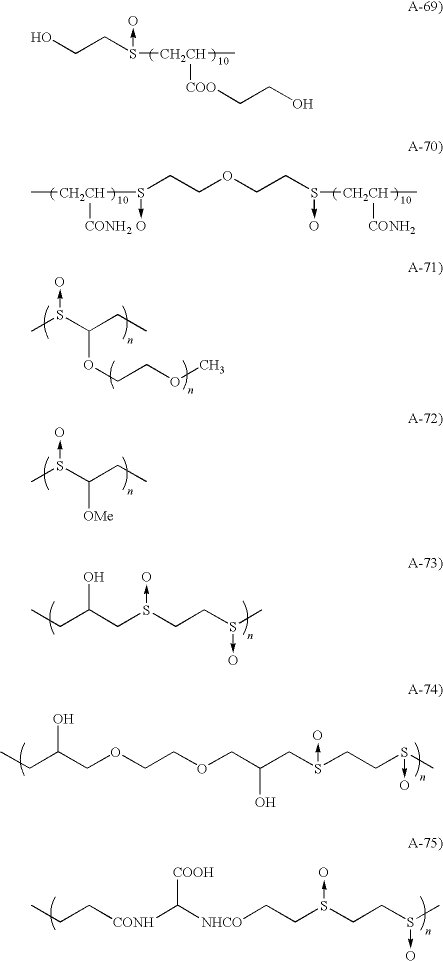

The content of the compound containing a sulfur atom in the inkjet receiving layer is preferably from 0.01 to 20 g/m², and more preferably from 0.05 to 7 g/m².

### [Inorganic Fine Particles]

Examples of the inorganic fine particles include silica fine particles, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide, and yttrium oxide. Silica fine particles, colloidal silica, alumina fine particles and pseudo-boehmite are preferable among them from the viewpoint of forming a good porous structure. The fine particles may be used as primary particles, or after forming secondary particles. The average primary particle diameter of these fine particles is preferably 2 μm or less, more preferably 200 nm or less.

Furthermore, silica fine particles with an average primary particle diameter of 20 nm or less, colloidal silica with an average primary particle diameter of 30 nm or less, alumina fine particles with an average primary particle diameter of 20 nm or less, and pseudo-boehmite with an average fine pore diameter of 2 to 15 nm are more preferable, and the silica fine particles, alumina fine particles and pseudo-boehmite are particularly preferable.

The silica fine particles are roughly classified into wet method particles and dry method (gas phase method) particles depending on their production method. In a typical example of the wet method, active silica is formed by acidolysis of a silicate salt, and active silica is polymerized to an adequate degree, and then is coagulated and precipitated to form hydrated silica. In contrast, in a typical example of the gas phase method, anhydrous silica is obtained by hydrolysis of silicon halide in gas phase at high temperature (flame hydrolysis method), or silica sand and coke are vaporized by reduction by heating with arc in an electric furnace, and the product thereof is oxidized with air (arc method). The “gas phase silica” means anhydrous silica fine particles obtained by the gas phase method. The gas phase silica fine particles are particularly preferable as the silica fine particles used in the invention.

Although the gas phase silica exhibits different properties from hydrated silica due to the difference in the density of the silanol groups on the surface and in the proportion of the voids, the gas phase silica is suitable for forming a three-dimensional structure having a high void ratio. While the reason thereof is not clear, the density of the silanol groups on the surface of the fine particles is as large as 5 to 8 groups/nm² in the case of hydrated silica, and thus the silica particles easily aggregate. In contrast, the density of the silanol group on the surface of the fine particles is as small as 2 to 3 groups/nm² in the case of gas phase silica, and thus the fine particles form coarse and soft aggregate (flocculate), thereby forming a structure having a high void ratio.

Since gas phase silica has a particularly large surface area, the efficiency for absorbing and retaining ink is high. In addition, owing to a low refractive index of gas phase silica, transparency can be rendered to the ink receiving layer by dispersing the particles to an adequate particle diameter, whereby high color density and good coloring property can be obtained. The transparency of the receiving layer is important for obtaining a high color density and good glossiness of colors, not only in the uses requiring high transparency such as an OHP film, but also in an application as a recording sheet such as a photographic glossy paper.

The average primary particle diameter of the inorganic fine particles (e.g., gas phase silica) is preferably 50 nm or less, more preferably from 3 to 50 nm, still more preferably from 3 to 30 nm, particularly preferably 3 to 20 nm, and most preferably 3 to 10 nm, in view of the quick drying property (ink absorption rate). Since the gas phase silica particles are liable to be coagulated with each other due to hydrogen bonds between the silanol groups, a structure having a large void ratio can be formed when the average primary particle diameter is 50 nm or less, and ink absorbing characteristics can be effectively improved.

The gas phase silica may be used together with other inorganic fine particles such as those described above. The content of gas phase silica is preferably 30 mass % or more, more preferably 50 mass % or more, when the gas phase silica is used together with other fine particles.

Alumina fine particles, alumina hydrate, and a mixture or composite thereof are also preferable as the inorganic fine particles used in the invention. The alumina hydrate is preferable among them since it absorbs ink well and fixes the ink, and pseudo-boehmite (Al₂O₃·nH₂O) is particularly preferable. While various forms of the alumina hydrate may be used, boehmite sol is preferably used as the raw material since a smooth layer can be readily obtained.

The fine void structure of pseudo-boehmite preferably has an average fine void diameter of 1 to 30 nm, more preferably 2 to 15 nm. The fine void volume is preferably 0.3 to 2.0 cc/g, more preferably 0.5 to 1.5 cc/g. The fine void diameter and fine void volume are measured by a nitrogen absorption-desorption method using, for example, a gas absorption-desorption analyzer (for example, OMNISORP 369 manufactured by Beckman Coulter, Inc.).

The gas phase alumina fine particles are preferable among the alumna fine particles due to their large surface area. The average primary particle diameter of the gas phase alumina is preferably 30 nm or less, more preferably 20 nm or less.

When the fine particles are used in the inkjet recording medium, for example, embodiments disclosed in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777 and 2001-301314 can also be used preferably.

### [Water-Soluble Resin]

Examples of the water-soluble resin used in the ink receiving layer include polyvinyl alcohol resins (e.g., polyvinyl alcohol (PVA), acetoacetyl-modified polyvinyl alcohol, cation-modified polyvinyl alcohol, anion-modified polyvinyl alcohol, silanol-modified polyvinyl alcohol and polyvinyl acetal), which are resins having hydroxyl groups as hydrophilic structural units, cellulose resins (methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose), chitins, chitosans, starches, resins having ether bonds (polyethylene oxide (PEO), polypropylene oxide (PPO), polyethyleneglycol (PEG) and polyvinyl ether (PVE)), and resins having carbamoyl groups (polyacrylamide (PAAM), polyvinyl pyrrolidone (PVP) and polyacrylic acid hydrazide).

Other examples include polyacrylic acid salts, maleic acid resins, alginic acid salts and gelatins, having carboxylic groups as dissociation groups.

The polyvinyl alcohol resins are particularly preferable among the resin above. Examples of the polyvinyl alcohol resins are described in Japanese Patent Application Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345 and 8-324105, 11-348417.

Examples of water-soluble resins other than polyvinyl alcohol resins include the compounds described in paragraph [0011] to [0014] in JP-A No. 11-165461.

Only one water-soluble resin may be used, or a combination of two or more water-soluble resins may be used.

The content of the water-soluble resin of the invention is preferably 9 to 40 mass %, more preferably 12 to 33 mass %, relative to the mass of the total solid content of the ink receiving layer.

The water-soluble resin and the inorganic fine particles, which are main constituents of the ink receiving layer according to the invention, each may be composed of a single material, or a mixture of plural materials.

The kind of the water-soluble resin to be combined with the inorganic fine particles, particularly silica fine particles, is important from the viewpoint of maintaining transparency. When gas phase silica is used, the water-soluble resin is preferably a polyvinyl alcohol resin. In particular, the polyvinyl alcohol resin preferably has a saponification degree of 70 to 100%, more preferably 80 to 99.5%.

While the polyvinyl alcohol resin has hydroxyl groups in its structural units, a three dimensional network structure with secondary particles of the silica fine particles as network chain units is readily formed since hydrogen bonds are formed between the hydroxyl groups and the silanol groups on the surface of the silica fine particles. It is considered that an ink receiving layer having a porous structure with a high void ratio and sufficient strength is formed owing to the formation of the three dimensional network structure.

The porous ink receiving layer obtained as described above rapidly absorbs ink by capillary action during inkjet recording, and thus dots of good circularity can be formed without ink bleed.

The polyvinyl alcohol resin may be used together with other water-soluble resins. The content of polyvinyl alcohol resin in the total water-soluble resins is preferably 50 mass % or more, more preferably 70 mass % or more, when the polyvinyl alcohol resin is used together with other water-soluble resins.

### <Composition Ratio Between Fine Particles and Water-Soluble Resin>

The mass composition ratio (PB ratio (x/y)) of inorganic fine particles (x) to water-soluble resin (y) largely affects the structure and strength of the ink receiving layer. While the void ratio, fine void volume and surface area (per unit mass) increase as the mass composition ratio (PB ratio) increases, the density and strength tend to be lowered.

The mass composition ratio (PB ratio, (x/y)) in the ink receiving layer of the invention is preferably in the range of 1.5 to 10, so as to prevent decrease in the layer strength and generation of cracks at drying resulting from an excessively large PB ratio, and so as to prevent decrease in ink absorbing property accompanying reduction of void ratio caused by easily occurring filling of voids with the resin resulting from an excessively small PB ratio.

Since the recording sheet may suffer stress when conveyed in a conveyer system of an inkjet printer, the ink receiving layer should have sufficient film strength. Sufficient strength of the ink receiving layer is required also for preventing cracks and peeling of the ink receiving layer when the recording sheet is cut into smaller sheets. The mass ratio (x/y) is preferably 5 or less in consideration of the above situation, and is preferably 2 or more from the viewpoint of ensuring high speed ink absorption in the inkjet printer.

A three dimensional network structure with the secondary particles of the silica fine particles as the network chains is formed, for example, by preparing a coating liquid in which gas phase silica fine particles with an average primary diameter of 20 nm or less and a water-soluble resin are completely dispersed in water in a mass ratio (x/y) of 2 to 5, applying the coating liquid onto a support, and then drying the coated layer, whereby a light-transmitting porous layer with an average fine void diameter of 30 nm or less, a void ratio of 50 to 80%, a specific void volume of 0.5 ml/g or more, and a specific surface area of 100 m²/g or more can be readily formed.

### (Crosslinking Agent)

In the inkjet recording medium according to the invention, the ink receiving layer preferably contains a water-soluble resin. The ink receiving layer is preferably a porous layer obtained by forming the coated layer containing the sulfoxide-containing compound, the cation polymer, the inorganic fine particles, the water-soluble resin and a crosslinking agent capable of crosslinking the water-soluble resin, and curing the coated layer through a crosslinking reaction between the crosslinking agent and the water-soluble resin.

Boron compounds are preferably used for crosslinking the water-soluble resin, particularly polyvinyl alcohol resin. Examples of the boron compound include borax, boric acid, borate (for example orthoborate, InBO3, ScBO₃, YBO3, LaBO₃, Mg₃(BO₃)₂ and CO₃(BO₃)₂), diborate (for example Mg₂B₂O₅, CO₂B₂O₅), methaborate (for example LiBO₂, Ca(BO₂)₂, NaBO₂ and KBO₂), tetraborate (for example Na₂B₄O₇·10H₂O), and pentaborate (for example KB₅O₈·4H₂O, Ca₂B₆O₁₁·7H₂O, and CsB₅O₅). Borax, boric acid and borates are preferable since they can cause crosslinking reaction quickly, and boric acid is particularly preferable.

The following compounds other than boron compounds may be used as the crosslinking agent for the water-soluble resin.

Examples of such other crosslinking agents include aldehyde compounds such as formaldehyde, glyoxal and glutaraldehyde; ketone compounds such as diacetyl and cyclopentanedione; active halogen compounds such as bis(2-chloroethylurea), 2-hydroxy-4,6-dichloro-1,3,5-triazine, 2,4-dichloro-6-triazine sodium salt; active vinyl compounds such as divinyl sulfonic acid, 1,3-divinylsulfonyl-2-propanol, N,N′-ethylenebis(vinylsulfonylacetamide), and 1,3,5-triaclyroyl-hexahydro-5-triazine; N-methylol compounds such as dimethylol urea and methylol dimethylhydantoin; melamine resins (for example, methylolmelamine, alkylated methylolmelamine; epoxy resins; isocyanate compounds such as 1,6-hexamethylene diisocyanate; aziridine compounds described in U.S. Pat. Nos. 3,017,280 and 2,983,611; carboxylmide compounds described in U.S. Pat. No. 3,100,704; epoxy compounds such as glycerol triglycidyl ether; ethylene imino compounds such as 1,6-hexamethylene-N,N′-bisethylene urea; halogenated carboxyaldehyde compounds such as mucochloric acid and mucophenoxy chloric acid; dioxane compounds such as 2,3-dihydroxydioxane, metal-containing compounds such as titanium lactate, aluminum sulfate, chromium alum, potassium alum, zirconium acetate and chromium acetate; polyamine compounds such as tetraethylenepentamine; hydrazide compounds such as dihydrazine adipate; and low molecular weight compounds or polymers containing at least two oxazoline groups.

Only a single crosslinking agent selected from the above may be used, or two or more crosslinking agents selected from the above may be used in combination.

As mentioned hereunder, crosslink curing is preferably carried out in the following manner: a crosslinking agent is added to a coating liquid containing inorganic fine particles, a water-soluble resin and the like (hereinafter occasionally referred to as “first liquid”) and/or to a basic solution having a pH of 7.1 or higher (hereinafter occasionally referred to as “second liquid”); onto the coated layer formed by application of the first liquid, the second liquid is applied (1) simultaneously with the application of the first liquid for forming the coated layer, or (2) before the coated layer exhibits decreasing drying during drying of the coated layer formed by application of the first liquid. In this case, the compound containing a sulfur atom is contained in either of the first or second liquid. Application of the crosslinking agent is preferably conducted as follows when a boron compound is used as an example. Namely, if the ink receiving layer is a layer obtained by crosslink-curing of a coated layer formed by application of the coating liquid (first liquid) containing fine particles and a water-soluble resin containing polyvinyl alcohol, the crosslink curing is carried out by applying the basic solution having a pH of 7.1 or higher (the second liquid) onto the coated layer (1) simultaneously with the application of the first liquid, or (2) before the coated layer exhibits decreasing drying during drying of the coated layer formed by application of the first liquid. The boron compound as a crosslinking agent may be contained at least one of the first and the second liquids, and may be contained in the both of the liquids.

The amount of crosslinking agent to be used is preferably from 1 to 50 mass %, and more preferably from 5 to 40 mass % with respect to the water-soluble resin.

### [Water-Soluble Polyvalent Metal Salt]

The ink receiving layer in the invention preferably contains a water-soluble polyvalent metal compound. As the water-soluble polyvalent metal compound used in the invention, trivalent or higher multivalent metal compounds are preferable. The polyvalent metal compound may be, for example, a water-soluble salt of a metal selected from calcium, barium, manganese, copper, cobalt, nickel, aluminum, iron, zinc, zirconium, chromium, magnesium, tungsten, and molybdenum.

Specific examples thereof include calcium acetate, calcium chloride, calcium formate, calcium sulfate, calcium butyrate, barium acetate, barium sulfate, barium phosphate, barium oxalate, barium naphthoresorcin carboxylate, barium butyrate, manganese chloride, manganese acetate, manganese formate dihydrate, ammonium manganese sulfate hexahydrate, cupric chloride, ammonium copper (II) chloride dihydrate, copper sulfate, copper (II) butyrate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, ammonium nickel sulfate hexahydrate, amide nickel sulfate tetrahydrate, nickel sulfaminate, nickel 2-ethylhexanoate, aluminum sulfate, aluminum sulfite, aluminum thiosulfate, aluminum polychloride, aluminum nitrate nonahydrate, aluminum chloride hexahydrate, aluminum acetate, aluminum lactate, basic aluminum thioglycolate, ferrous bromide, ferrous chloride, ferric chloride, ferric sulfate, ferrous sulfate, iron (III) citrate, iron (III) lactate trihydrate, triammonium iron (III) trioxalate trihydrate, zinc bromide, zinc chloride, zinc nitrate hexahydrate, zinc sulfate, zinc acetate, zinc lactate, zirconium acetate, zirconium tetrachloride, zirconium chloride, zirconium oxychloride octahydrate, zirconium hydroxychloride, chromium acetate, chromium sulfate, magnesium acetate, magnesium oxalate, magnesium sulfate, magnesium chloride hexahydrate, magnesium citrate nonahydrate, sodium tungstophosphate, tungsten sodium citrate, dodecatungstophosphate n-hydrate, dodecatungstosilicate hexacosahydrate, molybdenum chloride, dodecamolybdophosphate n-hydrate and the like, aluminum alum, basic aluminum polyhydroxide, zinc phenolsulfonate, ammonium zinc acetate, and ammonium zinc carbonate. Two or more of these water-soluble polyvalent metal compounds may be used together. In the invention, the term “water-soluble” regarding water-soluble polyvalent metal compounds means that the polyvalent metal compounds are dissolves, at a concentration of 1 mass % or more, in water of 20° C.

Among the above-described water-soluble polyvalent metal compounds, an aluminum compound or a compound containing a metal belonging to Group 4A of the Periodic Table (for example, zirconium or titanium) is preferable, and an aluminum compound is more preferable. Particularly preferred is a water-soluble aluminum compound. The water-soluble aluminum compound may be an inorganic salt whose examples are aluminum chloride and hydrates thereof, aluminum sulfate and hydrates thereof, and aluminum alum, or a basic aluminum polyhydroxide compound, which is an inorganic aluminum-containing cationic polymer; they can be preferably used in the invention.

The basic aluminum polyhydroxide compound means a water-soluble aluminum polyhydroxide the major component of which is represented by the following formula 1, 2, or 3, and contains stably a basic and high-molecular polynuclear condensation ion such as [Al₆(OH)₁₅]³⁺, [Al₈(OH)₂₀]⁴⁺, [Al₁₃(OH)₃₄]⁵⁺, and [Al₂₁(OH)₆₀]³⁺.

[Al₂(OH)ₙCl₆₋ₙ]ₘ formula 1

[Al(OH)₃]ₙAlCl₃ formula 2

Alₙ(OH)ₘCl₍₃ₙ₋ₘ₎ 0<m<3n formula 3

These compounds are supplied from Tagi Chemical Co., Ltd. under the name of aluminum polychloride (PAC) as a chemical for water treatment, from Asada Chemical Co., Ltd. under the name of aluminum polyhydroxide (Paho), from Riken Green Co., Ltd. under the name of HAP-25, from Taimei Chemicals Co., Ltd. under the name of ALUFINE 83, and from other manufacturers for the same purpose. Products of various grades are easily available.

As the water-soluble compound containing an element of Group 4A of the Periodic Table, water-soluble compounds containing titanium or zirconium are more preferable. Examples of a water-soluble compound containing titanium include titanium chloride, titanium sulfate, titanium tetrachloride, tetraisopropyl titanate, titanium acetylacetonate, and titanium lactate. Examples of a water-soluble compound containing zirconium include zirconium acetate, zirconium chloride, zirconium hydroxychloride, zirconium nitrate, basic zirconium carbonate, zirconium hydroxide, zirconium lactate, ammonium zirconium carbonate, potassium zirconium carbonate, zirconium sulfate, and zirconium fluoride compounds.

It is preferred that the water-soluble polyvalent metal compound is added in an amount of 0.1 to 10 mass %, and more preferably 0.5 to 8 mass % with respect to the inorganic fine particles.

### [Mordant]

In the invention, it is preferred that the ink receiving layer contains a mordant other than the water-soluble polyvalent metal compound in order to further improve the water resistance and the resistance to bleed with age of a formed image.

The mordant is preferably a cationic polymer (cationic mordant) that is an organic mordant, or an inorganic mordant. When the mordant is contained in the ink receiving layer, the mordant interacts with an anionic dye contained as a colorant in liquid ink to stabilize the colorant, thereby improving the water resistance and the resistance to bleed with age. Organic mordants and inorganic mordants each may be used alone. In an embodiment, one or more organic mordants and one or more inorganic mordants are used in combination.

As the cationic mordant, a polymer mordant having, as a cationic group, a primary, secondary, or tertiary amino group or a quaternary ammonium base is used in general. However, the cationic mordant may be a cationic non-polymer mordant in the invention.

Examples of the polymer mordant include: homopolymers of a monomer (mordant monomer) having a primary, secondary, or tertiary amino group, or a salt thereof, or a quaternary ammonium base; copolymers or condensation polymers of the mordant monomer and one or more other monomers (hereinafter referred to as “non-mordant monomer”). These polymer mordants may be used in the form of a water-soluble polymer or water-dispersible latex particles.

Examples of the monomer (mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, and N,N-dimethyl-N-phenyl-N-p-vinylbenzylammonium chloride, trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, and N,N-diethyl-N-methyl-N-2-(4-vinylphenyl)ethylammonium acetate, N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide, N,N-diethylaminopropyl(meth)acrylamide, and salts thereof (for example, hydrochlorides, nitrates, acetates, lactates, methanesulfonates, p-toluenesulfonates and the like), trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Examples of other mordant monomer include N-vinylimidazole, N-vinyl-2-methylimidazole, 2-vinylpyridine, 4-vinylpyridine, 4-vinyl-N-methylpyridinium chloride, 4-vinyl-N-ethylpyridinium bromide, dimethyldiallylammonium chloride, and monomethyldiallylammonium chloride.

Only one of such mordant monomers may be used, or two or more copolymerizable mordant monomers may be used in combination.

The non-mordant monomer refers to a monomer that does contain a basic or cationic portion such as a primary, secondary, or tertiary amino group or a quaternary ammonium salt, and that do not interact, or exhibit substantially small interaction, with the dye in ink-jet ink.

Examples of the non-mordant monomer include alkyl (meth)acrylates (for example C1-18 alkyl (meth)acrylates such as methyl (meth)acrylate, ethyl (meth)acrylate, propyl(meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate); cycloalkyl (meth)acrylates (such as cyclohexyl (meth)acrylate); aryl methacrylates (such as phenyl (meth)acrylate)); aralkyl (meth)acrylates (such as benzyl(meth)acrylate); substituted alkyl (meth)acrylates (such as 2-hydroxyethyl (meth)acrylate, methoxymethyl (meth)acrylate and allyl(meth)acrylate); (meth)acrylamides (such as (meth)acrylamide, dimethyl (meth)acrylamide, N-ethyl (meth)acrylamide, and N-isopropyl (meth)acrylamide); aromatic vinyls (styrene, vinyltoluene and α-methylstyrene); vinyl esters (such as vinyl acetate, vinyl propionate and vinyl versatate); allyl esters (such as allyl acetate); halogen-containing monomers (such as vinylidene chloride and vinyl chloride); vinyl cyanates (such as (meth)acrylonitrile); and olefins (such as ethylene and propylene).

Only one non-mordant monomer may be used, or two or more non-mordant monomers may be used in combination.

Examples of the polymer mordant include polyethyleneimine (and derivatives thereof), polyvinylamine (and derivatives thereof), polyallyamine (and derivatives thereof), polyamidine, cationic polysaccharides (such as cationic starch and chitosan), dicyan cationic resins (such as dicyan diamide-formalin polycondensate), polyamine cationic resins (such as dicyan diamide-diethylenetriamine polycondensate), epichlorohydrin-dimethylamine addition polymers, and dimethyldiallylammonium chloride-sulfur dioxide copolymer.

Polymers having a quaternary ammonium base are preferable, and (meth)acrylate polymers, vinylbenzylammonium polymers and diallylammonium polymers having weight average molecular weight of 1,000 to 100,000 and having a quaternary ammonium base are particularly preferable as the organic mordant in the invention.

In the invention, the content of the mordant in the ink receiving layer is preferably from 0.01 to 10 g/m², more preferably from 0.1 to 5 g/m².

The ink receiving layer coating liquid (first liquid) preferably contains a surfactant. As the surfactant, cationic surfactants, anionic surfactants, nonionic surfactants, amphoteric surfactants, fluorosurfactants, and silicone surfactants are all usable.

Examples of preferable nonionic surfactants include polyoxyalkylene alkylethers and polyoxyalkylene alkylphenylethers (such as diethyleneglycol monoethylether, diethyleneglycol diethylether, polyoxyethylene laurylether, polyoxyethylene stearylether and polyoxyethylene nonylphenylether); oxyethylene-oxypropylene block copolymers, sorbitan fatty acid esters (such as sorbitan monolaurate, sorbitan monooleate and sorbitan trioleate); polyoxyethylene sorbitan fatty acid esters (such as polyoxyethylene sorbitan monolaurate, polyoxyethylene sorbitan monoolelate and polyoxyethylene sorbitan trioleate); polyoxyethylene sorbitol fatty acid esters (such as tetra oleic acid polyoxyethylene sorbit); glycerin fatty acid esters (such as glycerol monooleate); polyoxyethylene glycerin fatty acid esters (such as monostearic acid polyoxyethylene glycerin and monooleic acid polyoxyethylene glycerin); polyoxyethylene fatty acid esters (such as polyethyleneglycol monolaurate, and polyethyleneglycol monooleate); polyoxyethylene alkylamines; and acetylene glycols (such as 2,4,7,9-tetramethyl-5-decyn-4,7-diol, and ethylene oxide adducts and propylene oxide adducts of the diol). Polyoxyalkylene alkylethers are preferable among them. The nonionic surfactant may be used in the first solution and the second solution. Only one nonionic surfactant may be used, or two or more nonionic surfactants may be used in combination.

Examples of amphoteric surfactants include those of amino acid type, carboxyamonium betaine type, sulfonammonium betaine type, ammonium sulfonic ester betaine type and imidazolium betaine type, and those described in U.S. Pat. No. 3,843,368, JP-A Nos. 59-49535, 63-236546, 5-303205, 8-262742 and 10-282619 may be favorably used. The amphoteric surfactant may be an amphoteric surfactant of amino acid type, which may be derived from an amino acid (such as glycine, glutamic acid or histidine) as described in JP-A No. 5-303205. Specifically, the amphoteric surfactant may be an N-aminoacyl acid having a long chain acyl group introduced thereto, or a salt thereof. Only a single amphoteric surfactant may be used, or two or more amphoteric surfactants may be used in combination.

Examples of anionic surfactants include fatty acid salts (for example, sodium stearate and potassium oleate), salts of alkylsulfuric acid esters (for example, sodium lauryl sulfate and triethanolamine lauryl sulfate), sulfonic acid slats (for example, sodium dodecylbenzene sulfonate), alkylsulfosuccinic acid salts (for example, sodium dioctylsulfosuccinate), alkyldiphenylether disulfonic acid salts, and alkylphosphoric acid salts.

Examples of cationic surfactants include alkylamine salts, quaternary ammonium salts, pyridinium salts and imidazolium salts.

Examples of fluorosurfactants include a compound derived from an intermediate having a perfluoroalkyl group using a method such as electrolytic fluorination, telomerization, or origomerization.

Examples of fluorosurfactants include perfluoroalkyl sulfonic acid salts, perfluoroalkyl carboxylic acid salts, perfluoroalkyl ethylene oxide adducts, perfluoroalkyl trialkyl ammonium salts, perfluoroalkyl group-containing oligomers, and perfluoroalkyl phosphoric acid esters.

The silicon surfactant is preferably a silicone oil modified with an organic group, which may have a structure in which a side chain of a siloxane structure is modified with the organic group, a structure in which the both terminals of a siloxane structure are modified with the organic group, or a structure in which one of the terminals of a siloxane structure is modified with the organic group. Examples of modification with the organic group include amino modification, polyether modification, epoxy modification, carboxyl modification, carbinol modification, alkyl modification, aralkyl modification, phenol modification and fluorine modification.

In the invention, the content of surfactant is preferably from 0.01 to 2.0%, more preferably from 0.01 to 1.0%, relative to the ink receiving layer coating liquid (the first liquid). When two or more coating liquids for forming the ink receiving layer are used for coating, it is preferable to add the surfactant to each coating liquid.

In the invention, the ink receiving layer preferably contains a high boiling point organic solvent for preventing curling. The high boiling point organic solvent is an organic compound having a boiling point of 150° C. or higher at atmospheric pressure, and is a water-soluble or hydrophobic compound. The high boiling point organic solvent may be solid or liquid at room temperature, and may be a low molecular weight compound or a high molecular weight compound.

Examples of the organic solvent include aromatic carboxylic acid esters (such as dibutyl phthalate, diphenyl phthalate and phenyl benzoate); aliphatic carboxylic acid esters (such as dioctyl adipate, dibutyl sebacate, methyl stearate, dibutyl maleate, dibutyl fumarate and triethyl acetylcitrate); phosphoric acid esters (such as trioctyl phosphate and tricresil phosphate); epoxy compounds (such as epoxylated soy bean oil and epoxylated fatty acid methyl esters); alcohols (such as stearyl alcohol, ethyleneglycol, propyleneglycol, diethyleneglycol, triethyleneglycol, glycerin, diethyleneglycol monobutylether (DEGMBE), triethyleneglycol monobutylether, glycerin monomethylether, 1,2,3-butanetriol, 1,2,4-butanetriol, 1,2,4-pentanetriol, 1,2,6-hexanetriol, thiodiglycol, triethanolamine and polyethyleneglycol); vegetable oils (such as soy bean oil and sunflower oil); and higher aliphatic carboxylic acid (such as linoleic acid and oleic acid).

### <Support>

The support used in the invention may be a transparent support made of a transparent material such as plastics, or an opaque support made of an opaque material such as paper. A transparent support or a highly glossy opaque support is preferably used for taking advantage of transparency of the ink receiving layer. In an embodiment, the support is a read-only optical disk such as a CD-ROM or a DVD-ROM, a write-once optical disk such as a CD-R and a DVD-R, or a rewritable optical disk, and the ink receiving layer is provided on the labeling face side.

The material used for the transparent support is preferably transparent and resistant to radiant heat generated when used with an OHP or a backlight display. Examples of the material include polyesters such as polyethylene terephthalate (PET); polysulfone, polyphenylene oxide, polyimide, polycarbonate and polyamide. Polyesters are preferable, and polyethylene terephthalate is particularly preferable among them.

While the thickness of the support is not particularly restricted, the thickness is preferably 50 to 200 μm from the viewpoint of ease of the handling.

The opaque support having high glossiness preferably has a surface with a glossiness of 40% or more on which the ink receiving layer is to be provided. The glossiness is measured according to the method (a 75 degree specular glossiness test method for paper sheets and paper board) defined in Japanese Industrial Standards (JIS) P-8142, which is incorporated herein by reference. Specific examples include the following supports.

Examples include highly glossy paper supports such as art paper, coat paper, cast-coat paper, and baryta paper used for silver salt photographic support; highly glossy films (which may have been subjected to a surface calendering treatment) comprising a plastic film that has been made opaque by adding a white pigment or the like, wherein the plastic film may be a polyester such as polyethylene terephthalate (PET), a cellulose ester such as nitrocellulose, cellulose acetate or cellulose acetate butylate, polysulfone, polyphenylene oxide, polyimide, polycarbonate or polyamide; and supports in which a coated layer of a polyolefin, which contains or does not contain a white pigment, on the surface of any of various paper supports as described above, a transparent support as described above, or a highly glossy film containing a white pigment or the like.

Foamed polyester films containing a white pigment (for example, foamed PET that contains polyolefin fine particles and voids formed by stretching) are also favorably used. Resin coat paper used for the silver salt photographic paper is also preferable.

While the thickness of the opaque support is not particularly restricted, it is preferably from 50 to 300 μm in consideration of ease of handling.

A corona discharge treatment, glow discharge treatment, flame treatment or UV irradiation treatment may be applied on the surface of the support for improving wettability and adhesive property.

The raw paper sheet used for the resin coat paper will be described in detail below.

The raw paper is produced using a wood pulp as a major material which may be added with a synthetic pulp such as polypropylene pulp, or synthetic fibers such as nylon or polyester fibers, as necessary. While any one of LBKP, LBSP, NBKP, NBSP, LDP, NDP, LUKP and NUKP may be used as the wood pulp, it is preferable to use a greater amount of LBKP, NBSP, LBSP, NDP and LDP, which contain a high proportion of short fibers, than other wood pulps.

However, the proportion of LBS and/or LDP is preferably 10 mass % or more and 70 mass % or less.

Chemical pulps (such as sulfate pulp and sulfite pulp) containing little impurity may be preferably used, and a pulp whose brightness has been improved by a bleaching treatment is also useful.

The following agents may be added to the raw paper sheet as necessary: a sizing agent such as a higher fatty acid and alkylketene dimer; white pigment such as calcium carbonate, talc and titanium oxide; a paper strength enhancer such as starch, polyacrylamide and polyvinyl alcohol; a fluorescent brightener; a humectant such as polyethyleneglycol; a dispersing agent; a softening agent such as quaternary ammonium; and the like.

The freeness of the pulp to be used for paper-making is preferably from 200 to 500 ml as defined in CSF. Regarding the fiber length after beating, the sum of the percentage by mass of the 24 mesh filtration residue and the percentage by mass of the 42 mesh filtration residue is preferably 30 to 70 mass %. Such mesh filtration residues are defined in JIS P-8207, which is incorporated herein by reference. The percentage by mass of the 4 mesh filtration residue is preferably 20 mass % or less.

The basis weight of the raw paper is preferably from 30 to 250 g/m², particularly preferably from 50 to 200 g/m². The thickness of the raw paper is preferably from 40 to 250 μm. High smoothness can be rendered to the raw paper by applying a calender treatment during paper making or after paper making. The density of the raw paper is usually from 0.7 to 1.2 g/m³ (JIS P-8118, which is incorporated herein by reference).

The rigidity of the raw paper is preferably from 2 to 20 mN·m under the condition according to JIS P-8125, which is incorporated herein by reference.

The surface of the raw paper sheet may be coated with a surface sizing agent, which may be selected from the above-described examples of sizing agents that can be incorporated into the interior of the raw paper.

The pH of the raw paper is preferably from 5 to 9 when measured by a hot water extraction method according to JIS P-8113, which is incorporated herein by reference.

While polyethylene used for coating the front and back surfaces of the raw paper may contain, as a main component, a low density polyethylene (LDPE) and/or a high density polyethylene (HDPE). However, LLDPE, polypropylene, and the like may also be used as a component.

The polyethylene layer on the side to be provided with the ink receiving layer is preferably obtained by adding titanium oxide of rutile or anatase type, fluorescent brightener and ultramarine blue to polyethylene such that opaqueness, whiteness, and hue are improved, as widely adopted in photographic paper. The content of titanium oxide relative to polyethylene is preferably from 3 to 20 mass %, more preferably from 4 to 13 mass %. While the thickness of the polyethylene layer is not particularly restricted, a thickness of 10 to 50 μm is favorable for both the layers on the front and back sides. An undercoat layer may be provided on the polyethylene layer so as to provide the polyethylene layer with adhesiveness to the ink receiving layer. Aqueous polyester, gelatin and PVA are preferable as the undercoat layer. The thickness of the undercoat layer is preferably from 0.01 to 5 μm.

The polyethylene coated paper may be used as glossy paper, or may be used as paper having such a matte surface or silky surface as realized in usual photographic paper if a so-called embossing treatment is conducted when polyethylene is coated on the raw paper by melt-extrusion.

A back coat layer may be provided on the support, and components that can be added to the back coat layer may be, for example, a white pigment, an aqueous binder and the like.

Examples of the white pigment contained in the back coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene-based plastic pigments, acrylic plastic pigments, polyethylene, microcapsules, urea resin and melamine resin.

Examples of the aqueous binder usable in the back coat layer include water-soluble polymers such as styrene/maleic acid salt copolymer, styrene/acrylic acid salt copolymer, polyvinyl alcohol, silanol-modified polyvinyl alcohol, starch, cationized starch, casein, gelatin, carboxymethyl cellulose, hydroxyethyl cellulose and polyvinyl pyrrolidone; and water dispersible polymers such as styrene-butadiene latex and acrylic emulsion.

Other components that can be contained in the back coat layer include defoaming agents, foaming suppressing agents, dyes, fluorescent brighteners, antiseptics and water-proofing agent.

### <Method for Manufacturing Inkjet Recording Medium>

A method according to an embodiment of the invention for manufacturing an inkjet recording medium is a method for manufacturing the inkjet recording medium of the invention. The method includes forming an ink receiving layer by a process including at least the following (A) and (B), and at least one of the following first liquid and the second liquid contains a compound containing sulfur.

(A): applying a first liquid containing at least a water-soluble resin and a crosslinking agent onto a support to form a coated layer on the support.

(B): applying a second liquid containing a basic compound onto the coated layer (1) simultaneously with the application of the first liquid, or (2) before the coated layer exhibits decreasing drying during drying of the coated layer formed by the application of the first liquid, to crosslink and cure the coated layer.

In a method for manufacturing the inkjet recording medium according to the second embodiment described above, a sulfoxide-containing compound is used as the compound containing a sulfur atom.

According to another embodiment, a method for manufacturing an inkjet recording medium of the invention is a method for manufacturing an inkjet recording medium having an ink receiving layer including a compound containing a sulfur atom, wherein the center plane average roughness (SRa value) on the surface of the ink receiving layer is 11 nm or less when measured under a condition of a cutoff of 2 to 2.5 μm. The method includes forming the ink receiving layer by a process including at least the following (A) and (B), at least one of the following first and second liquids contains a compound containing a sulfur atom, and the viscosity of the first liquid before exhibiting decreasing drying is 6000 Pa or more at a shear rate of 1 s⁻¹.

(A) applying a first liquid containing at least a water-soluble resin and a crosslinking agent onto a support to form a coated layer on the support.

(B) applying a second liquid containing a basic compound onto the coated layer (1) simultaneously with the application of the first liquid, or (2) before the coated layer exhibits decreasing drying during drying of the coated layer formed by the application of the first liquid, to crosslink and cure the coated layer.

The present embodiment is a method for manufacturing an inkjet recording medium which does not belong to the above-mentioned first or second embodiment of the inkjet recording medium according to the invention, wherein the inkjet recording medium has an ink receiving layer including a compound containing a sulfur atom, and the center plane average roughness (SRa value) on the surface of the ink receiving layer is 11 nm or less when measured under a condition of a cutoff of 2 to 2.5 μm.

It is preferred to provide the ink receiving layer thus crosslink-cured in view of ink absorbing property and prevention of film crack.

Although the compound containing a sulfur atom may be contained in any of the first and second liquids, it is more preferably contained in the first liquid in view of the surface condition of the ink receiving layer.

In the invention, the first liquid preferably contains the inorganic fine particles. When the coating liquid for forming an ink receiving layer (the first liquid) contains at least inorganic fine particles (e.g. gas phase silica) and a water-soluble resin (e.g. polyvinyl alcohol), the coating liquid can be prepared, for example, in the following manner. Namely, inorganic fine particles such as gas phase silica and a dispersing agent are added to water (e.g. 10 to 20 mass % of silica fine particles in the water). The mixture is dispersed in a condition of high-speed rotation of, for example, 10000 rpm (preferably 5000 to 20000 rpm) for, for example, 20 minutes (preferably 10 to 30 minutes) by using a beads mill (for example, “KD-P” manufactured by Shima Enterprise Co., Ltd.). Thereafter, a sulfoxide-containing compound (compound containing a sulfur atom) and a polyvinyl alcohol (PVA) aqueous solution are added to the dispersion liquid. The amount of PVA is, for example, such an amount that the mass of PVA is one-third of the mass of the gas phase silica. The resulting mixture is dispersed in the same rotation condition as described above, whereby the coating liquid is obtained. It is preferred to adjust the pH of the coating liquid to around 9.2 with aqueous ammonia or the like, or to use a dispersing agent in order to render stability to the coating liquid. The resulting coating liquid is in a homogeneous sol state. When the coating liquid is applied onto a support by the following coating method, and is dried, a porous ink receiving layer having a three-dimensional network structure can be formed.

When the water dispersion containing the gas phase silica and the dispersing agent is prepared, a previously-prepared water dispersion of the gas phase silica may be added to an aqueous solution of the dispersing agent, or an aqueous solution of the dispersing agent may be added to a water dispersion of the gas phase silica, or they may be mixed simultaneously. As an alternative, powder of the gas phase silica may be added to the aqueous solution of the dispersing agent, instead of the water dispersion of the gas phase silica.

In an embodiment, after the gas phase silica and the dispersing agent are mixed, the mixture liquid is treated with a disperser, so that the particle size is reduced to give a water dispersion containing particles with an average particle diameter of 50 nm or less.

In order to set the center plane average roughness (SRa value) on the surface of the ink receiving layer at less than 6 nm when measured under a condition of a cut off of 2 to 2.5 μm, it is preferable to use a head-on collision high pressure disperser or an orifice-passing high pressure disperser, as described above. Descriptions for the head-on collision high pressure disperser and the orifice-passing high pressure disperser are omitted in this section since they are already described in the above sections.

The solvent used in each process may be water, an organic solvent or a mixture of liquids selected from water and organic solvents. Organic solvents usable for coating include alcohols such as methanol, ethanol, n-propanol, i-propanol and methoxypropanol, ketones such as acetone and methylethyl ketone, tetrahydrofuran, acetonitrile, ethyl acetate and toluene.

A dispersing agent may be added for improving dispersibility of the coating liquid. The dispersing agent is not particularly limited, and may be a known cationic dispersing agent.

The amount of the dispersing agent to be added is preferably from 0.1 to 30%, more preferably from 1 to 10%, relative to the amount of the inorganic fine particles.

The pH of the first liquid is not particularly restricted, and is preferably from 2.0 to 6.0, more preferably from 3 to 5. Bleeding of image with time can be suppressed when the ink receiving layer is formed from the coating liquid having a pH of 2 to 6.

The ink receiving layer coating liquid (first liquid) can be applied by a known coating method using an extrusion die coater, an air doctor coater, a blade coater, a rod coater, a knife coater, a squeeze coater, a reverse roll coater or a bar coater.

The second liquid is applied onto the coated layer (i) simultaneously with the application of the coating liquid for forming an ink receiving layer (first liquid), or (ii) before the coated layer exhibits decreasing drying during drying of the coated layer formed by the application of the first liquid. More specifically, the ink receiving layer is suitably manufactured by introducing the second liquid during constant drying of the coated layer after the application of the coating liquid for forming an ink receiving layer (first liquid). The second liquid may contain a mordant.

The second liquid may contain a crosslinking agent or other mordant components as necessary. When the second liquid is used in the form of an alkaline solution, hardening of the film can be promoted. The solution is preferably adjusted to have a pH of 7.1 or higher, more preferably 7.5 or higher, and particularly preferably 7.9 or higher. When the pH is too close to the acidic side, the crosslinking reaction of the water-soluble polymer contained in the first liquid caused by the crosslinking agent does not proceed sufficiently, so that there are cases where bronzing occurs or defects such as cracking occurs in the ink receiving layer.

The second liquid may be prepared, for example by adding a metal compound (e.g. 1 to 5%), a basic compound (e.g. 1 to 5%), and optionally paratoluenesulfonic acid (e.g. 0.5 to 3%) to ion-exchange water, and agitating the resultant mixture liquid sufficiently. The “%” values for the respective components each mean a mass % of the solid content.

The expression “before the coated layer exhibits decreasing drying rate” usually refers to a process within a few minutes from immediately after the application of the coating liquid for forming an ink receiving layer, during which a phenomenon, “constant drying rate”, is observed. The constant drying rate refers to a proportional decrease in content of the solvent (dispersion medium) in the coated layer to time. The time during which the “constant drying rate” is observed is described, for example, in “Kagaku Kogaku Binran (Handbook of Chemical Engineering) (pages 707 to 712, published from Maruzen Co., Ltd. on Oct. 25, 1980).

As described above, the coated layer is dried after the first liquid is applied until the coated layer exhibits a constant rate of drying. In general, the drying is carried out at 40 to 180° C. for 0.5 to 10 minutes (preferably 0.5 to 5 minutes). The drying time naturally differs depending on the amount of the coating liquid to be applied, but the above range is usually preferable.

The viscosity at a shear rate of 1 s⁻¹ of the first liquid before exhibiting decreasing drying is preferably 6000 Pa or more, more preferably 7000 Pa or more, and particularly preferably from 8000 to 10000 Pa. When the viscosity of the first liquid before exhibiting decreasing drying is 6000 Pa or more at a shear rate of 1 s⁻¹, the center plane average roughness (SRa) on the surface of the ink receiving layer measured under a condition of a cutoff of 2 to 2.5 μm can be 11 nm or less.

The viscosity may be measured by sampling the coating liquid from the support when the coating liquid is dried until immediately before the coated layer exhibits a decreasing drying rate after application of the first liquid, and measuring the liquid with RHEOSTRESS 600.

Adjustment of the viscosity of the coated layer can be carried out by addition of an organic solvent such as an alcohol to the coating liquid.

Examples for applying the second liquid before the first coated layer exhibits a decreasing drying rate include (1) a method of further applying the second liquid onto the coated layer; (2) a method of spraying the second liquid with a spray or the like; (3) a method of immersing the support having the coated layer provided thereon in the second liquid, and the like.

The method usable for applying the second liquid in the method (1) may be a known coating method such as methods using a curtain flow coater, an extrusion die coater, an air doctor coater, a blade coater, a rod coater, a knife coater, a squeeze coater, a reverse roll coater or a bar coater. However, methods in which the coater does not directly contact the already formed first coated layer are preferable, such as an extrusion die coater, a curtain flow coater and a bar coater.

After applying the second liquid, the ink receiving layer is usually heated to 40 to 180° C. for 0.5 to 30 minutes so as to be dried and cured. Heating to 40 to 150° C. for 1 to 20 minutes is particularly preferable.

When the second liquid is applied simultaneously with the application of the coating liquid for forming the ink receiving layer (first liquid), the first liquid and second liquid are simultaneously applied (dual layer coating) onto the support such that the first liquid contacts the support, and then are dried and cured to form the ink receiving layer.

The simultaneous application (dual layer coating) can be performed by a coating method using, for example, an extrusion die coater or a curtain flow coater. The resultant coated layer is dried after the simultaneous application. The drying is conducted usually by heating the coated layer to 40 to 150° C. for 0.5 to 10 minutes, preferably to 40 to 100° C. for 0.5 to 5 minutes.

When the simultaneous application (dual layer coating) is conducted, for example with an extrusion die coater, the simultaneously extruded two coating liquids form a dual layer in the vicinity of the discharge port of the extrusion die coater before being transferred onto the support, and the dual layer is applied onto the support as it is. Since the two coating liquids in the dual layer before application already tend to cause crosslinking reaction at the interface between the two coating liquids during transfer onto the support, the extruded two liquids are likely to mix and become viscous in the vicinity of the discharge port of the extrusion die coater, in which case, application operation are sometimes troublesome. Accordingly, when the simultaneous coating is conducted as described above, it is preferable to further provide a barrier layer liquid (an intermediate layer liquid) between the first coating liquid and the second coating liquid at the time of the application of the first and second liquids, so as to form a triple layer.

The barrier layer liquid may be selected without particular restrictions, and may be, for example, an aqueous solution containing a trace amount of water-soluble resin, or water. The water-soluble resin is added as a thickener in consideration of coatability. The water-soluble resin may be a polymer, whose examples include cellulose resins (such as hydroxylpropylmethyl cellulose, methyl cellulose and hydroxyethyl cellulose), polyvinyl pyrrolidone and gelatin. The barrier layer liquid may contain a mordant such as those described above.

The surface smoothness, glossiness, transparency and coated layer strength can be improved by applying a calender treatment by passing through a roll nip under heat and pressure using a super calender or a gloss calender after forming an ink receiving layer on a support. However, since the calender treatment may cause a decrease of the void ratio (, which may result in decrease in ink absorbing property), a condition giving smaller decrease in the void ratio should be employed.

The roll temperature at the calender treatment is preferably from 30 to 150° C., more preferably from 40 to 100° C.

The linear pressure between the rolls at the calender treatment is preferably from 50 to 400 kg/cm, more preferably from 100 to 200 kg/cm.

Since the ink receiving layer should have an enough absorption capacity to absorb all the droplets in the ink-jet recording, the thickness of the ink receiving layer should be determined in relation to the void ratio in the layer. For example, the thickness should be about 15 μm or more when the amount of ink is 8 mL/mm² and the void ratio is 60%.

Considering these points, the thickness of the ink receiving layer is preferably from 10 to 50 μm in the case of ink-jet recording.

The diameter of the void in the ink receiving layer is preferably from 0.005 to 0.030 μm, more preferably from 0.01 to 0.025 μm, in terms of a median diameter.

The void ratio and median diameter can be measured with a mercury porosimeter (trade name: PORESIZER 9320-PC2, manufactured by Shimadzu Corporation).

The pH of the surface of the ink receiving layer of the invention is preferably from 3 to 6, more preferably from 3.5 to 4.5. The pH on the surface is measured in 30 seconds using water according to the J. TAPPI Paper and Pulp Test Method No. 49, which is incorporated herein by reference. Image storability is improved when the pH is 3 or more, while water resistance is improved when the pH is 6 or less, thereby enabling more efficient suppression of bleeding under a high humidity condition. Accordingly, resistance to bleeding over time, ozone resistance and light fastness can be improved when the pH of the surface is from 3 to 6.

The ink receiving layer preferably has high transparency. As a rough guide, when the ink receiving layer is formed on a transparent film support, the haze value is preferably 20 or less, more preferably 15 or less.

The haze value can be measured with a haze meter (trade name: HGM-2DP, manufactured by Suga Test Instrument Co., Ltd.).

A dispersion of polymer fine particles may be added to the layers constituting the inkjet recording medium according to the invention (for example, the ink receiving layer or a back layer). This polymer fine particle dispersion is used for improving film properties such as dimensional stability, prevention of curl, prevention of adhesion and prevention of crack. The polymer fine particle dispersion is described, for example in JP-A Nos. 62-245258, 62-1316648 and 62-110066. Cracking and curling of the layer can be prevented by adding a polymer fine particle dispersion having a low glass transition temperature (40° C. or less) in the layer containing the mordant. Curling may be also prevented by adding a polymer fine particle dispersion having a high glass transition temperature to the back layer. The disclosure of Japanese Patent Application No. 2005-282489 is incorporated herein by reference in its entirety.

In the following, exemplary embodiments of the invention will be described.

<1> An inkjet recording medium comprising an ink receiving layer provided on a support, wherein the ink receiving layer includes a compound containing a sulfur atom, and the center plane average roughness (SRa value) on the surface of the ink receiving layer is less than 6 nm when measured under a condition of a cutoff of 2 to 2.5 μm.

<2> The inkjet recording medium as described in <1>, wherein the compound containing a sulfur atom is a compound containing a thioether group, or a sulfoxide-containing compound.

<3> The inkjet recording medium as described in <1>, wherein the compound containing a sulfur atom is a sulfoxide-containing compound.

<4> An inkjet recording medium comprising an ink receiving layer provided on a support wherein the ink receiving layer includes a sulfoxide-containing compound, and the center plane average roughness (SRa value) on the surface of the ink receiving layer is 11 nm or less when measured under a condition of a cutoff of 2 to 2.5 μm.

<5> The inkjet recording medium as described in any one of <1> to <4> wherein a haze value of the ink receiving layer is 20 or less.

<6> The inkjet recording medium as described in any one of <1> to <5>, wherein the pH of the surface of the ink receiving layer is from 3 to 6.

<7> A method for manufacturing the inkjet recording medium as described in any one of <1> to <6>, the method comprising at least:

(A) applying at least a first liquid containing a water-soluble resin and a crosslinking agent onto a support to form a coated layer on the support; and

(B) applying a second liquid containing a basic compound onto the coated layer (1) simultaneously with the application of the first liquid, or (2) before the coated layer exhibits decreasing drying during drying of the coated layer formed by the application of the first liquid, to crosslink and cure the coated layer to form an ink receiving layer;

wherein at least one of the first and second liquids includes a compound containing sulfur.

<8> The method for manufacturing an inkjet recording medium as described in <7>, wherein the viscosity of the first liquid before exhibiting decreasing drying is 6000 Pa or more at a shear rate of 1 s⁻¹.

<9> The method for manufacturing an inkjet recording medium as described in <7> or <8>, wherein the first liquid further includes inorganic fine particles.

<10> The method for manufacturing an inkjet recording medium as described in any one of <7> to <9>, wherein the water-soluble resin is polyvinyl alcohol.

<11> The method for manufacturing an inkjet recording medium as described in any one of <7> to <10>, wherein the crosslinking agent is boric acid.

<12> The method for manufacturing an inkjet recording medium as described in any one of <7> to <11>, wherein the pH of the first liquid is 6.0 or less, and the pH of the second liquid is 7.1 or more.

<13> A method for manufacturing the inkjet recording medium as described in any one of <1> to <4>, the method comprising dispersing at least some of the components of a coating liquid for forming the ink receiving layer with a head-on collision high-pressure disperser or an orifice-passing high-pressure disperser during a preparation process of the coating liquid.

<14> A method for manufacturing an inkjet recording medium comprising an ink receiving layer that includes a compound containing a sulfur atom and has a surface whose center plane average roughness (SRa value) is 11 nm or less when measured under a condition of a cutoff of 2 to 2.5 μm, the method comprising at least:

(A) applying a first liquid containing at least a water-soluble resin and a crosslinking agent onto a support to form a coated layer on the support;

(B) applying a second liquid containing a basic compound onto the coated layer (1) simultaneously with the application of the first liquid, or (2) before the coated layer exhibits decreasing drying during drying of the coated layer formed by the application of the first liquid, to crosslink and cure the coated layer to form an ink receiving layer,

wherein at least one of the first and second liquids includes a compound containing sulfur, and the viscosity of the first liquid before exhibiting decreasing drying is 6000 Pa or more at a shear rate of 1 s⁻¹.

### EXAMPLES

In the following, the present invention is specifically described by reference to Examples. However, the Examples should not be construed as limiting the invention. In the Examples, “part” and “%” mean “part by mass” and “mass %”, respectively, unless otherwise mentioned.

Pulp slurry was prepared by beating 50 parts of LBKP made of acacia and 50 parts of LBKP made of aspen with a disk free refiner to a Canadian Freeness of 300 ml.

Then, 1.3% of a cationic starch (trade name: CATO 304L, manufactured by Japan NSC Corporation), 0.15% of anionic polyacrylamide (trade name: DA4104, manufactured by Seiko PMC Corporation), 0.29% of an alkylketen dimer (trade name: SIZEPINE K, manufactured by Arakawa Chemical Industries, Ltd.), 0.29% of epoxylated behenic acid amide, and 0.32% of polyamide polyamine epichlorohydrin (trade name: ARAFIX 100, manufactured by Arakawa Chemical Industries, Ltd.) per pulp were added to the resulting pulp slurry, and then 0.12% of antifoaming agent was added thereto.

The pulp slurry prepared as described above was used for papermaking with a fourdrinier. The felt face of the resulting web was pushed forcibly to a drum dryer cylinder by a dryer canvas so as to be dried. During the drying, the tensile force of the dryer canvas was set at 1.6 kg/cm. Then, 1 g/m² of polyvinyl alcohol (trade name: KL-118, manufactured by Kuraray Co., Ltd.) was applied onto both sides of the raw paper with a size press, followed by drying. Then, a calendering treatment was carried out. The basis weight of the raw paper was 166 g/m², and the obtained raw paper (base paper) had a thickness of 160 μm.

The wire face (rear side) of the resultant base paper was subjected to corona discharge treatment. Thereafter, high-density polyethylene was applied onto the wire face to a thickness of 25 μm with a melt extruder to form a thermoplastic resin layer constituting a matte surface (hereinafter the surface of the thermoplastic resin layer is referred to as “backside”). The thermoplastic resin layer on the backside was further subjected to a corona discharge treatment; and then a dispersion liquid containing aluminum oxide (trade name: ALUMINASOL 100, manufactured by Nissan Chemical Industries, Co., Ltd.) and silicate dioxide (trade name: SNOWTEX 0, manufactured by Nissan Chemical Industries, Co., Ltd.) as antistatic agents in a mass ratio of 1:2 dispersed in water was applied to give a dry mass of 0.2 g/m², whereby a support was obtained.

### —Preparation of Liquid A (First Liquid) for Forming Ink Receiving Layer—

(1) Gas phase silica fine particles, (2) ion-exchange water, (3) “Sharol DC-902P”, and (4) “ZA-30” in the following composition were mixed, and the mixture was dispersed with a beads mill (for example, KD-P manufactured by Shinmaru Enterprises Corporation). Then, the dispersion liquid was heated to 45° C. and kept at the temperature for 20 hours. Thereafter, the following (5) boric acid, (6) polyvinyl alcohol solution, (7) “SUPERFLEX 600”, (8) polyoxyethylene laurylether, and (9) compound A (the above-described exemplary compound “A-41” as an example of the sulfoxide-containing compound) were added to the dispersion liquid at 30° C., so that a coating liquid A (first liquid) for forming an ink receiving layer was prepared. The mass ratio of the silica fine particles to the water-soluble resin (PB ratio=(1):(6)) was 4.5:1, and the pH of the coating liquid A for forming an ink receiving layer was 3.8, which was acidic.

### <Composition of the Coating Liquid A (First Liquid) for Forming an Ink Receiving Layer>

| | | |
|---|---|---|
| (1) Gas phase silica fine particles (inorganic fine particles) | 8.9 | parts |
| (trade name: AEROSIL 300SF75, | | |
| manufactured by Nippon Aerosil Co., Ltd.) | | |
| (2) Ion-exchange water | 51.8 | parts |
| (3) “SHAROL DC-902P” (51.5% aqueous solution) | 0.78 | part |
| (Dispersing agent, | | |
| manufactured by Dai-ichi Kogyo Seiyaku Co., Ltd.) | | |
| (4) “ZA-30” | 0.48 | part |
| (manufactured by Daiichi Kigenso Kagakukogyo Co., Ltd.) | | |
| (5) Boric acid (crosslinking agent) | 0.33 | part |
| (6) Polyvinyl alcohol (water-soluble resin) solution | 26.0 | parts |
| (Composition of the solution: | 1.8 | parts) |
| “PVA235” manufactured by Kraray Co., Ltd., | | |
| with a saponification degree of 88% | | |
| and a polymerization degree of 3500 | | |
| Polyoxyethylene laurylether (Surfactant) | 0.02 | part |
| The following compound 1 | 0.05 | part |
| Diethyleneglycol monobutylether | 0.6 | part |
| (trade name: BUTYCENOL 20P manufactured by | | |
| Kyowa Hakko Chemical Co., Ltd.) | | |
| Ion-exchange water | 22.7 | parts |
| (7) “SUPERFLEX 600” | 1.11 | parts |
| (manufactured by Dai-ichi Kogyo Seiyaku Co., Ltd.) | | |
| (8) Polyoxyethylene laurylether (surfactant) | 0.44 | part |
| (trade name: “EMULGEN 109P” (10% aqueous solution), | | |
| HLB value: 13.6, manufactured by Kao Corporation) | | |
| (9) Compound A (the exemplary compound “A-41” | 0.43 | part |
| as an example of the sulfoxide-containing compound) | | |

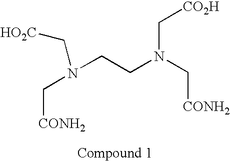

### —Production of Inkjet Recording Medium—

The front surface of the support was subjected to corona discharge treatment. Then, 170 ml/m² of the first liquid together with 10.8 ml/m² of five-fold diluted aqueous solution of poly aluminum chloride (trade name: “ALUFINE 83”, manufactured by Taimei Chemicals Co., Ltd.) were in-line coated on the front surface of the support (coating process). Then, drying was conducted at 80° C. (at a wind velocity of 3 to 8 m/sec) in a hot-air dryer until the solid concentration of the coated layer became 24%. The coated layer exhibited a constant drying rate in this period. Immediately thereafter, the support was immersed in the second coating liquid having the following composition for 3 seconds, so that 13 g/m² of the second coating liquid adhered to the coated layer (process of applying a mordant solution). Then, drying was further conducted at 72° C. for 10 minutes (drying process). As a result, an inkjet recording medium according to the invention having an ink receiving layer whose dry film thickness was 32 μm was obtained.

### <Composition of Second Liquid>

| | | |
|---|---|---|
| (1) Boric acid | 0.65 | part |
| (2) Ammonium zirconyl carbonate | 2.5 | parts |
| (trade name: ZIRCOZOL AC-7 (28% aqueous solution), | | |
| manufactured by Daiichi Kigenso Kagaku Kogyo Co., Ltd.) | | |
| (3) Ammonium carbonate | 4.0 | parts |
| (Primary: Kanto Chemical co., Inc.) | | |
| (4) Ion-exchange water | 89.4 | parts |
| (5) Polyoxyethylene laurylether (surfactant) | 6.0 | parts |
| (trade name: “EMULGEN 109P”, manufactured by Kao | | |
| Corporation; (10% aqueous solution), HLB value: 13.6) | | |

### Example 2

An inkjet recording medium was produced in the same manner as in Example 1 except that the compound A contained in the coating liquid A (first liquid) for forming an ink receiving layer was replaced by the following compound B (a compound containing thioether groups), and 0.8 part of ethanol was also contained in the coating liquid A.

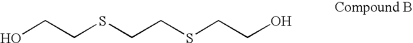

### Example 3

An inkjet recording medium was produced in the same manner as in Example 1 except that the disperser was replaced by a solution-to-solution collision disperser (ULTIMAIZER manufactured by Sugino Machine Corporation) in the preparation of the coating liquid A for forming an ink receiving layer.

### Comparative Example 1

An inkjet recording medium was produced in the same manner as in Example 1 except that the compound A was not contained in the coating liquid A (first liquid) for forming an ink receiving layer, and 2.3 parts of ethanol was also contained in the coating liquid A.

### Comparative Example 2

An inkjet recording medium was produced in the same manner as in Example 1 except that 2.3 parts of ethanol was also contained in the coating liquid A (first liquid) for forming an ink receiving layer.

### Comparative Example 3

An inkjet recording medium was produced in the same manner as in Comparative Example 2 except that the compound A contained in the coating liquid A (first liquid) for forming an ink receiving layer was replaced with the same amount of the compound B.

The following evaluations were conducted on each of the inkjet recording media obtained in Examples and Comparative Examples. The evaluation results are shown in Table 1.

### (1) Center Plane Average Roughness (SRa Value)

The center plane average roughness (SRa value) was measured with New View 5022 manufactured by Zygo Corporation at a cutoff of 2 to 2.5 μm based on the following measurement and analysis conditions.

### <Measurement and Analysis Conditions>

Measurement length: 5 mm in X-direction, 5 mm in Y-direction
Objective lens: 10 magnification
Bandpass filter: 2 to 2.5 μm

### (2) Viscosity of Coating Liquid

After application of the first liquid, the coating liquid which was dried until the coated layer exhibited a decreasing drying rate was sampled from the support, and the liquid was measured with RHEOSTRESS 600.

### (3) Evaluation of Ozone Resistance

A magenta solid image was printed on each of the inkjet recording media by using an inkjet printer (trade name: “PMG-950C”, manufactured by Seiko-Epson Corporation loaded with a genuine ink set, and images of person and landscape were further printed. The resultant images were allowed to stand in an ozone atmosphere at a concentration of 3 ppm for 12 hours. Thereafter, the degree of chromatism and decrease in concentration of the respective colors in each image was observed in accordance with naked eye, and evaluated according to the following evaluation criteria.

### Evaluation Criteria

A: Color fading was scarcely observed

B: Slight color fading was observed

C: Considerable color fading was observed

D: Degree of color fading was severe

### (4) Evaluation of Image Density

A black solid image was printed on each of the recording media with an inkjet printer (trade name: “PMG-800C”, manufactured by Seiko-Epson Corporation) loaded with a genuine ink set. The concentration in the black area was measured with a reflection densitometer (trade name: XRITE 938, manufactured by Xrite Corporation).

### (5) Cracking

Cracks in the produced inkjet recording media were evaluated with naked eye.

A: No crack was observed

B: Fine cracks were observed

C: Remarkable cracks were observed

TABLE 1

| | | | | Comparative | Comparative | Comparative |
|---|---|---|---|---|---|---|
| | Example 1 | Example 2 | Example 3 | Example 1 | Example 2 | Example 3 |
| Compound containing sulfur | Compound A | Compound B | Compound A | None | Compound A | Compound B |
| atom | | | | | | |
| Center plane average roughness | 9 | 10 | 5 | 8 | 13 | 12 |
| (SRa)/nm | | | | | | |
| Haze value | 19.6 | 20.6 | 13 | 20.6 | 24.3 | 21 |
| Coating liquid (first liquid) | 7000 | 6000 | 7500 | 8000 | 2000 | 1000 |
| viscosity (Pa) | | | | | | |
| Ozone resistance (%) | A | A | A | D | A | A |
| Image density | 2.05 | 2.03 | 2.2 | 2.05 | 1.90 | 1.92 |
| Cracking | A | A | A | A | B | C |

As is clear from Table 1, the image density was high and the ozone resistance was excellent in the case of the inkjet recording media of Examples 1 to 3. On the other hand, the ozone resistance was insufficient in the case of the inkjet recording medium of Comparative Example 1 containing no sulfur compound, and the image density was decreased in the case of the inkjet recording media of Comparative Examples 2 and 3 whose center plane average roughness (SRa value) was outside the range defined in the invention.

According to the invention, an inkjet recording medium can be provided which has excellent ozone resistance and capable of suppressing decrease in image density. A method for manufacturing such an inkjet recording medium is also provided.

All publications, patent applications, and technical standards mentioned in this specification are herein incorporated by reference to the same extent as if each individual publication, patent application, or technical standard was specifically and individually indicated to be incorporated by reference.

1. An inkjet recording medium comprising an ink receiving layer provided on a support, wherein the ink receiving layer includes a compound containing a sulfur atom, and a center plane average roughness (SRa value) on a surface of the ink receiving layer is less than 6 nm when measured under a condition of a cutoff of 2 to 2.5 μm.

2. The inkjet recording medium according to claim 1, wherein the compound containing a sulfur atom is a compound containing a thioether group, or a sulfoxide-containing compound.

3. The inkjet recording medium according to claim 1, wherein the compound containing a sulfur atom is a sulfoxide-containing compound.

4. (canceled)

5. The inkjet recording medium according to claim 1, wherein a haze value of the ink receiving layer is 20 or less.

6. The inkjet recording medium according to claim 1, wherein a pH of a surface of the ink receiving layer is from 3 to 6.

7. A method for manufacturing the inkjet recording medium according to claim 1, the method comprising:
(A) applying at least a first liquid containing a water-soluble resin and a crosslinking agent onto a support to form a coated layer on the support; and
(B) applying a second liquid containing a basic compound onto the coated layer (1) simultaneously with the application of the first liquid, or (2) before the coated layer exhibits decreasing drying during drying of the coated layer formed by application of the first liquid, to crosslink and cure the coated layer to form an ink receiving layer;
wherein at least one of the first and second liquids includes a compound containing sulfur.

8. The method for manufacturing an inkjet recording medium according to claim 7, wherein a viscosity of the first liquid before exhibiting decreasing drying is 6000 Pa or more at a shear rate of 1 s⁻¹.

9. The method for manufacturing an inkjet recording medium according to claim 7, wherein the first liquid further includes inorganic fine particles.

10. The method for manufacturing an inkjet recording medium according to claim 7, wherein the water-soluble resin is polyvinyl alcohol.

11. The method for manufacturing an inkjet recording medium according to claim 7, wherein the crosslinking agent is boric acid.

12. The method for manufacturing an inkjet recording medium according to claim 7, wherein a pH of the first liquid is 6.0 or less, and a pH of the second liquid is 7.1 or more.

13. A method for manufacturing the inkjet recording medium according to claim 1, the method comprising dispersing at least some of the components of a coating liquid for forming the ink receiving layer with a head-on collision high-pressure disperser or an orifice-passing high-pressure disperser during a preparation process of the coating liquid.

14. A method for manufacturing an inkjet recording medium comprising an ink receiving layer that includes a compound containing a sulfur atom and has a surface whose center plane average roughness (SRa value) is 11 nm or less when measured under a condition of a cutoff of 2 to 2.5 μm, the method comprising at least:
(A) applying a first liquid containing at least a water-soluble resin and a crosslinking agent onto a support to form a coated layer on the support;
(B) applying a second liquid containing a basic compound onto the coated layer (1) simultaneously with the application of the first liquid, or (2) before the coated layer exhibits decreasing drying during drying of the coated layer formed by the application of the first liquid, to crosslink and cure the coated layer to form an ink receiving layer,
wherein at least one of the first and second liquids includes a compound containing sulfur, and a viscosity of the first liquid before exhibiting decreasing drying is 6000 Pa or more at a shear rate of 1 s⁻¹.

15. An inkjet recording medium comprising an ink receiving layer provided on a support, wherein the ink receiving layer includes a sulfoxide-containing compound, and a center plane average roughness (SRa value) on a surface of the ink receiving layer is 11 nm or less when measured under a condition of a cutoff of 2 to 2.5 μm.

16. The inkjet recording medium according to claim 15, wherein a haze value of the ink receiving layer is 20 or less.

17. The inkjet recording medium according to claim 15, wherein a pH of a surface of the ink receiving layer is from 3 to 6.

18. A method for manufacturing the inkjet recording medium according to claim 15, the method comprising:
(A) applying at least a first liquid containing a water-soluble resin and a crosslinking agent onto a support to form a coated layer on the support; and
(B) applying a second liquid containing a basic compound onto the coated layer (1) simultaneously with the application of the first liquid, or (2) before the coated layer exhibits decreasing drying during drying of the coated layer formed by application of the first liquid, to crosslink and cure the coated layer to form an ink receiving layer;
wherein at least one of the first and second liquids includes a compound containing sulfur.

19. The method for manufacturing an inkjet recording medium according to claim 18, wherein a viscosity of the first liquid before exhibiting decreasing drying is 6000 Pa or more at a shear rate of 1 s⁻¹.

20. The method for manufacturing an inkjet recording medium according to claim 18, wherein the first liquid further includes inorganic fine particles.

21. The method for manufacturing an inkjet recording medium according to claim 18, wherein the water-soluble resin is polyvinyl alcohol.

22. The method for manufacturing an inkjet recording medium according to claim 18, wherein the crosslinking agent is boric acid.

23. The method for manufacturing an inkjet recording medium according to claim 18, wherein a pH of the first liquid is 6.0 or less, and a pH of the second liquid is 7.1 or more.
